(19) United States
(12) Patent Application Publication
(10) Pub. No.: US 2026/0316397 A1
(43) Pub. Date: Oct. 15, 2026

(54) SYSTEMS AND METHODS FOR CREATING THREE-DIMENSIONAL SCULPTURES OF ATHLETIC SWINGS

(71) Applicant: Swing Sculpt, Providence, RI (US)

(72) Inventor: Levi Kase, Providence, RI (US)

(73) Assignee: Swing Sculpt, Providence, RI (US)

(21) Appl. No.: 19/642,913

(22) Filed: Apr. 9, 2026

Related U.S. Application Data
(60) Provisional application No. 63/786,013, filed on Apr. 9, 2025.

(51) Int. Cl. B29C 64/393; A63B 24/00; A63B 71/06; B33Y 50/02; B33Y 80/00; G06F 3/01; G06T 7/20; G06T 7/50; G06T 7/70; G06T 7/80; G06V 10/82; G06V 40/10; G06V 40/20

(52) U.S. Cl. CPC B29C 64/393; A63B 24/0006; A63B 71/0619; B33Y 50/02; B33Y 80/00; G06F 3/016; G06T 7/20; G06T 7/50; G06T 7/70; G06T 7/80; G06V 10/82; G06V 40/10; G06V 40/23; A63B 2071/0655; A63B 2220/806; A63B 2225/20; A63B 2225/50; A63B 2225/74; G06T 2207/10016; G06T 2207/10028; G06T 2207/20081; G06T 2207/20084; G06T 2207/30196; G06T 2207/30221

(57) ABSTRACT

A system and method for creating three-dimensional sculptures based on the motion of a golf swing or other athletic movement. The system captures video data of a swing using one or more cameras, reconstructs the three-dimensional path of a tracked object—such as a golf club head—using triangulation, depth estimation, or geometric calibration, and generates a digital model by lofting or sweeping cross-sectional profiles along the path. The resulting model is fabricated into a physical sculpture using additive or subtractive manufacturing. In some embodiments, the system includes a visualization interface for reviewing or editing the path before fabrication. The sculpture may include features such as variable geometry, embedded lighting, haptic feedback, or augmented reality integration. The system is adaptable to other sports, including tennis, baseball, figure skating, and basketball, enabling commemorative and analytic representations of dynamic athletic motion.

### CROSS REFERENCE TO RELATED APPLICATION

This application claims the benefit of U.S. provisional Application No. 63/786,013 filed on Apr. 9, 2025, which is incorporated by reference as if fully set forth.

### FIELD OF THE INVENTION

The present invention relates generally to the field of motion capture and three-dimensional modeling, and more particularly to systems and methods for generating three-dimensional representations of athletic movements, such as golf swings, from video data and fabricating physical sculptures based on such representations.

### BACKGROUND OF THE INVENTION

Prior approaches have addressed portions of the problem of capturing or reconstructing golf-swing motion, but they have generally focused on motion analysis, simulation, or computer-vision reconstruction rather than converting motion-derived data into a personalized physical artifact, wearable object, or interactive replay object.

For example, U.S. Pat. No. 5,772,522 to Nesbit et al. describes a method and system for analyzing a golf club swing using a three-dimensional android model of a golfer, a dynamic model of a golf club, and motion capture using cameras and reflective markers placed on the golfer and club. The captured marker-path data is processed to derive three-dimensional angular motions, which are then used for kinematic and kinetic analysis of the swing and club performance. Nesbit et al. is primarily directed to biomechanical analysis and simulation of a golf swing, including forces, torques, and club behavior, rather than creation of a fabricated commemorative object or other consumer product derived from the motion path.

U.S. Patent Application Publication No. 2013/0190098 to Kirally et al. describes a golf club head measurement system in which markers are placed on the club face and imaged by a stereoscopic camera system to determine club-head path, face orientation, impact location, and related swing parameters. Kirally et al. further describes optional use of inertial sensors and display of measured swing characteristics. While this publication addresses measurement of club-head motion and impact characteristics, it is directed to swing analysis, club fitting, and measurement, not to generating a manufactured three-dimensional sculpture, wearable article, or interactive playback artifact from the captured motion.

Academic work has also addressed reconstructing motion or scene geometry from image sequences. Urtasun, Fleet, and Fua, in “Monocular 3-D Tracking of the Golf Swing,” describe reconstructing a three-dimensional model of a golf swing from monocular video using a motion model and optimization framework. That work is directed to computer-vision tracking and reconstruction of human and club motion from ordinary video, and does not address transformation of motion-derived trajectory data into a fabricated object.

More generally, structure-from-motion and SLAM techniques have been developed to estimate camera poses and three-dimensional scene structure from image collections or video. For example, Schönberger and Frahm, in “Structure-from-Motion Revisited,” describe an incremental structure-from-motion pipeline including feature extraction, matching, geometric verification, image registration, triangulation, and bundle adjustment. Likewise, Teed and Deng, in “DROID-SLAM: Deep Visual SLAM for Monocular, Stereo, and RGB-D Cameras,” describe a deep-learning-based SLAM system that iteratively updates camera poses and depth through a dense bundle-adjustment layer. These works are directed to general-purpose three-dimensional reconstruction and localization, not to creating physical or wearable products that embody an athletic motion trajectory.

Other work has addressed learned depth and motion estimation from monocular or multiview video. Zhou et al., in “Unsupervised Learning of Depth and Ego-Motion from Video,” describe an unsupervised learning framework that estimates depth and ego-motion from monocular video by using view synthesis as supervision. Teed and Deng, in “DeepV2D: Video to Depth with Differentiable Structure from Motion,” describe an end-to-end architecture that alternates depth estimation and motion estimation to predict depth from video. These techniques may recover depth, camera motion, or scene geometry from video, but they remain directed to reconstruction itself rather than downstream generation of a personalized fabricated object, jewelry item, or interactive replay piece based on captured athletic motion.

Accordingly, although prior systems have addressed golf-swing analysis, club-head measurement, monocular tracking, structure-from-motion, SLAM, and learned video-based depth or motion reconstruction, a need remains for systems and methods that transform captured athletic motion data into customized three-dimensional artifacts. A further need remains for systems and methods that can derive a three-dimensional path or other motion representation from one or more images or videos, convert that data into manufacturable geometry, and produce a physical sculpture, wearable article, or interactive object that commemorates or replays the motion in a meaningful and aesthetically customized way.

Each of the following references is incorporated herein by reference in its entirety for all purposes to the extent permitted: U.S. Pat. No. 5,772,522 to Nesbit et al.; U.S. Patent Application Publication No. 2013/0190098 to Kirally et al.; Urtasun et al., “Monocular 3-D Tracking of the Golf Swing”; Schönberger and Frahm, “Structure-from-Motion Revisited”; Teed and Deng, “DROID-SLAM: Deep Visual SLAM for Monocular, Stereo, and RGB-D Cameras”; Zhou et al., “Unsupervised Learning of Depth and Ego-Motion from Video”; and Teed and Deng, “DeepV2D: Video to Depth with Differentiable Structure from Motion.”

### SUMMARY OF THE INVENTION

The present invention provides systems and methods for transforming captured athletic motion into physical, three-dimensional artifacts. In various embodiments, motion data corresponding to an athletic action is obtained from one or more video sources and processed to generate a three-dimensional trajectory of a tracked object, body portion, or other motion-derived feature. The three-dimensional trajectory is then used to generate a digital model of a physical object, which may be fabricated as a sculpture, commemorative display piece, wearable article, instructional aid, collectible object, or interactive replay artifact.

In certain embodiments, the motion data is obtained from a plurality of cameras viewing an athletic motion from different perspectives. Two-dimensional motion paths extracted from the video sources are combined using triangulation or other multiview reconstruction techniques to determine a three-dimensional trajectory of an athletic object, such as a golf club head, racquet head, bat, ball, skate blade, or body-derived point. In other embodiments, the motion data is obtained from a single camera, and the three-dimensional trajectory is reconstructed using machine-learning-based depth estimation, calibrated geometric reconstruction, or combinations of learned and geometric reconstruction techniques.

In certain embodiments, a monocular video sequence is processed using one or more machine-learning models configured to detect and track an object of interest, estimate depth, infer a three-dimensional path, and refine the resulting trajectory using temporal smoothing, confidence filtering, event detection, reprojection consistency, or user correction. In further embodiments, a single-camera reconstruction is performed using calibration references and scene geometry to determine camera parameters and infer three-dimensional positions from image-plane observations subject to one or more geometric constraints, such as club-length constraints, body-pose constraints, ground-plane constraints, event-anchor constraints, or motion-continuity constraints.

In various embodiments, the reconstructed trajectory is converted into a digital three-dimensional model by defining a body along the trajectory. The body may be generated by fitting a spline, centerline, polyline, or other curve to the reconstructed positions and then performing one or more geometric operations, including lofting, sweeping, extrusion, shelling, thickening, faceting, or ribbing. The resulting body may have a tubular, ribbon-like, prismatic, shell-like, lattice, or other geometry. In certain embodiments, one or more geometric attributes of the body vary along the trajectory as a function of motion-derived attributes, such as speed, acceleration, curvature, torsion, tempo, transition timing, impact timing, angular motion, or other characteristics of the captured athletic action.

In some embodiments, the system provides a visualization interface through which a user may inspect, rotate, zoom, validate, edit, or approve the reconstructed trajectory before fabrication. The system may display time-indexed points, event markers, uncertainty indicators, projected detections, or derived motion metrics. User input may be used to correct or refine the reconstructed trajectory before generation of the digital model.

In various embodiments, the digital model is fabricated using additive manufacturing, subtractive manufacturing, casting, machining, or other manufacturing techniques. The fabricated object may be formed from metal, polymer, resin, composite, ceramic, wood, or combinations thereof, and may be mounted on a display base, incorporated into a commemorative structure, or formed as a wearable article. In certain embodiments, the fabricated object includes a mounting feature, interface element, or attachment structure for use with a base, chain, post, ring band, bracelet structure, clasp, or other supporting component.

In some embodiments, the invention provides an interactive physical artifact configured to replay one or more aspects of the underlying athletic motion. A physical body generated from the reconstructed trajectory may be coupled to a control subsystem that drives one or more output devices according to playback data derived from the reconstructed motion. The output devices may include light-emitting elements, haptic actuators, speakers, or other output components arranged in or on the physical body and/or an associated support base. The control subsystem may generate a time-varying replay of the athletic motion by sequentially activating light emitters along the trajectory, generating event-based haptic outputs, producing synchronized audio, or presenting combinations thereof. In certain embodiments, the system further includes one or more sensors for detecting user presence, touch, proximity, gesture, motion, or environmental conditions, and playback may be initiated or modified based on sensor input.

In further embodiments, the invention is adaptable to athletic motions beyond golf. The system may reconstruct and physically represent motions associated with tennis, baseball, basketball, figure skating, hockey, lacrosse, volleyball, soccer, martial arts, dance, and other sports or performances. Depending on the application, the reconstructed motion may correspond to an implement path, ball trajectory, body-part path, center-of-mass path, contact volume, motion envelope, or multiple coordinated motion primitives. In certain embodiments, the system selects a sport-specific reconstruction workflow, event taxonomy, geometry-generation rule set, or manufacturing profile based on the athletic activity represented in the captured data.

In still further embodiments, the invention provides wearable objects and miniature personal artifacts derived from reconstructed athletic motion. A motion-derived geometry may be converted into a pendant, earring, ring, bracelet, cuff, charm, pin, or other wearable or ornamental article by applying one or more transformations adapted for wearability and manufacturability. Such transformations may include scaling, smoothing, local thickening, edge rounding, balance adjustment, attachment-feature generation, orientation optimization, self-intersection avoidance, structural reinforcement, and material-specific adaptation. In certain embodiments, the wearable object further includes a gemstone seat, inlay, engraving, authentication feature, digital identifier, or other personalization feature associated with the underlying athletic motion.

Accordingly, the invention provides a unified platform for converting athletic motion data into tangible, customizable, and optionally interactive physical forms. By bridging motion capture, three-dimensional reconstruction, digital modeling, and fabrication, the disclosed systems and methods enable athletic movement to be preserved, analyzed, displayed, commemorated, replayed, or worn as a physical artifact.

### BRIEF DESCRIPTION OF THE DRAWINGS

FIG. 1A is a perspective view of a three-dimensional sculpture representing a golf swing, modeled according to a reconstructed club head trajectory.

FIG. 1B is a side view of the sculpture of FIG. 1A, illustrating the variation in curvature and thickness along the swing path.

FIG. 1C is a top-down view of the sculpture of FIG. 1A, further illustrating the continuous motion path through the backswing, downswing, and follow-through.

FIG. 2A is a visualization of a point cloud generated from motion capture data, representing the spatial position of the club head over time.

FIG. 2B shows a swing path fitted to the point cloud of FIG. 2A using interpolation or spline-fitting techniques.

FIG. 3A illustrates a two-dimensional sketch of a reconstructed swing path within a CAD environment.

FIG. 3B shows construction planes placed along the swing path for generating cross-sectional profiles.

FIG. 3C depicts a series of geometric profiles drawn on the construction planes.

FIG. 3D illustrates the initiation of a lofting operation connecting the profiles to form a continuous body.

FIG. 3E shows an intermediate result of the loft operation generating a smoothed 3D surface.

FIG. 3F illustrates the completed 3D model of the swing sculpture.

FIG. 3G shows a zoomed-in view of the transition between adjacent profiles along the lofted body.

FIG. 3H is a final view of the sculpture model prepared for export and manufacturing.

FIG. 4A is a screenshot of a visualizer used to inspect a reconstructed swing path before modeling.

FIG. 4B presents an alternate viewing angle of the visualized swing path.

FIG. 4C shows the swing path with annotated, time-indexed points for temporal inspection.

FIG. 5A illustrates a sculpture in raw CAD form with visible sketch points derived from swing data.

FIG. 5B shows a rotated view of the model and spline path formed from the sketch points.

FIG. 5C provides a close-up of the lofted geometry built along the path.

FIG. 6 is a process flow diagram showing a method for generating a swing sculpture from dual-camera video input using triangulation and CAD modeling.

FIG. 7 is a process flow diagram showing a method for generating a swing sculpture from single-camera video input using machine learning-based depth estimation.

FIG. 8 is a process flow diagram showing a method involving visual inspection, user validation, and CAD modeling of a reconstructed swing path.

### DETAILED DESCRIPTION

In a first embodiment, the invention provides a system and method for generating a three-dimensional (3D) sculpture based on the motion path of a golf club head during a golf swing, using dual-camera video capture, 3D path reconstruction, computer-aided design (CAD) modeling, and additive manufacturing.

The process begins with the acquisition of two video recordings of a golfer performing a swing. One video is captured from a position behind the golfer, aligned with the intended direction of ball flight (“down-the-line” view), and the other is captured from a position facing the golfer (“front” view). Both cameras are positioned approximately 8 to 10 feet from the golfer and at a height of approximately 5 feet from the ground to ensure the golf club head is visible throughout the entirety of the swing.

Following video acquisition, the motion of the golf club head is tracked in each video to produce a two-dimensional (2D) path of motion. The tracking may be performed manually, semi-automatically, or automatically using video analysis or computer vision techniques. Each of the two 2D paths corresponds to the projected motion of the club head in the image plane of each camera.

The two 2D paths are then input into a triangulation algorithm that reconstructs the 3D path of the golf club head during the swing. In one implementation, the triangulation process samples a fixed number of time-synchronized points along each 2D path and calculates corresponding three-dimensional coordinates using geometric principles. The result is a 3D trajectory composed of approximately 75 spatial coordinate points (x, y, z), which represent the motion of the club head throughout the swing.

This set of 3D coordinate data is exported in a structured data format, such as a comma-separated values (.csv) file, and imported into a CAD environment such as Autodesk® Fusion 360®. A custom script or program, written using the Fusion API, processes the coordinate data and constructs a 3D model representing the path of the swing. In one example, the path is rendered as a continuous solid body having a cross-sectional shape of a triangular prism. The size of the prism may vary along its length to reflect swing dynamics—such as speed, direction change, or intensity—by modulating the thickness of the structure.

In a particular implementation, the sculpture begins with a relatively narrow cross-section near the address position. The thickness increases during the backswing, decreases toward the transition at the top of the swing, increases again during the downswing, and then tapers off during the follow-through. This variation in cross-sectional dimensions may be defined algorithmically based on predefined percentages of swing progression or derived from kinematic data.

The modeled sculpture includes an integrated threaded screw or protrusion at its base, designed to mate with a corresponding threaded recess in a display base. The display base may be made of wood or another material and is shaped as a cylindrical platform with a height of approximately 20 mm. A threaded hole is positioned approximately 15 mm from the edge of the base to receive and support the sculpture at an angle that accurately reflects the spatial orientation of the swing.

Once the model is complete, it is exported in a 3D-printable format, such as STL, and sent to a manufacturing facility where the sculpture is fabricated via metal additive manufacturing. The finished metal sculpture is then mounted on the prepared wooden base for display.

This embodiment may also include alternative versions of the sculpture featuring different cross-sectional shapes, such as square prisms, or variations in material finish, mounting hardware, or labeling. The system is adaptable to other sports involving swinging motions, including tennis, baseball, and hockey, by capturing and processing analogous motion data.

In a second embodiment, the system enables the creation of a 3D-printed sculpture of a golf swing using a single-camera video and automated depth estimation powered by machine learning. This embodiment is designed for consumer use, allowing users to generate swing sculptures from a mobile device or a standard camera without requiring a specialized dual-camera setup.

The user captures a video of a golf swing using a smartphone or tablet placed approximately 8 to 10 feet from the golfer at an elevation of about 5 feet from the ground. In contrast to the first embodiment, only one camera angle—typically the “down-the-line” view—is required.

The recorded video is uploaded to a server or processed locally using an application that includes a trained neural network model for depth estimation. The model is capable of reconstructing a rough 3D path of the golf club head by analyzing changes in pixel motion, perspective, and inferred depth cues from the video frames. In one example, the model uses a temporal convolutional neural network that tracks the club head frame-by-frame and predicts its 3D coordinates over time.

To enhance accuracy, the software may prompt the user to mark the location of the club head at the beginning and end of the swing or allow them to draw a rough path. These optional inputs help calibrate the tracking and reduce false positives from background motion.

The estimated 3D swing path is smoothed and interpolated to create a continuous line consisting of approximately 75 (x, y, z) points. These coordinates are automatically translated into a 3D model in which the swing path is rendered as a helically twisted ribbon or an organic ribbon-like surface rather than a prism. This shape introduces an aesthetic flair while preserving the data-driven trajectory of the club head.

In this embodiment, the ribbon's width and curvature may be varied dynamically to reflect metrics such as club head speed, tempo, or transition smoothness, as inferred from the timing and curvature of the path. For example, high-speed sections may be rendered with a tighter twist or wider flare, while slower sections may appear thinner and more minimal. This variation provides a unique, personalized artistic signature for each user's swing.

The sculpture includes a base-integrated QR code engraved in the metal or etched into the wooden stand. Scanning the code takes the viewer to an augmented reality (AR) visualization of the original swing video, synchronized with a 3D model, allowing digital exploration of the swing in parallel with the physical sculpture.

Users may select material and finish options (e.g., matte black aluminum, chrome steel, titanium) and preview the rendering in the app before ordering. The entire process—from video to visualization to ordering—can be completed via a mobile interface.

This second embodiment dramatically reduces hardware requirements, enhances accessibility for non-technical users, and expands the system's potential use cases to include events, corporate gifts, player development programs, and social sharing. It also demonstrates that the invention can extend beyond traditional CAD workflows to incorporate AI-driven modeling and augmented reality integrations.

In a third embodiment, the invention provides a system and method for generating a three-dimensional sculpture of a golf swing from a single-camera video using known camera calibration techniques and environmental reference markers.

In this implementation, a user records a video of a golf swing from a single static camera placed in the “down-the-line” position, approximately 8 to 10 feet behind the golfer and 5 feet above the ground. Prior to recording, a calibration target is placed in the frame—such as a checkerboard pattern, ArUco marker grid, or known reference object (e.g., a vertical pole with evenly spaced markings). The calibration target allows the system to estimate camera parameters and projective geometry with sufficient accuracy to reconstruct 3D trajectories.

After video capture, the system processes the frames to extract the 2D path of the golf club head. The club head may be manually tagged or tracked using object recognition and motion prediction algorithms. The extracted 2D path is then combined with the known geometry of the calibration target to estimate the relative position of the camera and map the 2D club head path into 3D space through inverse projection.

In one implementation, the calibration process uses a pinhole camera model to compute intrinsic (focal length, optical center) and extrinsic (position and orientation) parameters. With these parameters known, the 2D coordinates of the club head in each frame are transformed into estimated 3D coordinates, assuming the club head remains at a predictable height above the ground during specific phases of the swing (e.g., address, impact).

The reconstructed 3D path consists of approximately 75 (x, y, z) coordinates, representing the club head's motion through time. This trajectory is then imported into a CAD environment such as Fusion 360, where a parametric model is generated. In this embodiment, the 3D swing path is rendered as a smooth tube with a circular cross-section, and its diameter may vary based on inferred swing dynamics—such as acceleration or rotational velocity.

A special feature of this embodiment is the inclusion of a time-based gradient or ribbing structure along the sculpture's length. For example, evenly spaced ridges or color variations may represent specific time intervals or key swing events (e.g., takeaway, transition, impact, finish), giving the sculpture both a visual rhythm and educational value.

The model includes a base attachment feature designed to anchor the sculpture to a standardized display base. The base may include engraved labels or timestamps to identify swing stages or performance metrics derived from the data.

This embodiment allows for accurate 3D reconstruction using accessible recording equipment (e.g., a smartphone) and simple reference markers, without the need for AI or dual-camera systems. It is well-suited for golf instructors, amateur players, and consumers who want a physical representation of their swing captured from a single video session with minimal setup.

In a fourth embodiment, the invention encompasses an interactive system that transforms a golfer's swing into a multi-sensory experience by integrating a physical sculpture with dynamic lighting and haptic feedback. This embodiment extends the concept beyond static representation, allowing the user to see, feel, and even replay the motion of the swing in a vivid, immersive format.

As with prior embodiments, a video of a golf swing is captured and processed to extract a three-dimensional trajectory of the golf club head over time. The path may be reconstructed using a dual-camera setup, a single-camera system with depth estimation, or geometric calibration techniques. The resulting three-dimensional coordinate set defines the exact motion of the club head through space and time.

This embodiment uses that data to fabricate a physical sculpture formed from a semi-transparent resin material. The sculpture follows the path of the swing as a smooth, continuous tube or ribbon, visually representing the full motion arc from takeaway to follow-through. Embedded along the interior of the sculpture is a flexible strip of addressable light-emitting diodes (LEDs) which are routed through the hollow core. The LED array is programmed to animate a pulse of light along the path of the swing, replaying the motion in real time or in adjustable playback speeds.

The sculpture is mounted on an intelligent display base, crafted from wood, metal, or composite material, with an internal cavity that houses electronic components including a microcontroller, a proximity or motion sensor, and a series of haptic actuators. When a user touches the base or moves their hand near it, the system activates. A light animation is triggered within the sculpture, tracing the path of the swing as if the club were moving through the air. Simultaneously, the base delivers timed vibrations corresponding to key moments in the swing, such as the transition at the top of the backswing, the moment of impact, and the end of the follow-through. This tactile feedback provides a physical rhythm that mirrors the original motion.

In some implementations, the base includes a Bluetooth module that allows the sculpture to sync with a companion mobile application. Through the app, the user can select various playback modes, including a real-time replay of the swing matching the original tempo, a slow-motion mode for enhanced visualization, or a swing comparison mode where two sculptures—such as a “before” and “after” version of the swing—pulse light alternately to highlight differences in movement. The base may also incorporate a small speaker to play audio cues, such as the sound of the club striking the ball or a voiceover analysis provided by a coach.

Personalization features can further enhance the experience. The base may be laser-etched with data including the player's name, swing speed, date, and location of the captured swing. The lighting color scheme can be customized to reflect the player's personal style, team affiliation, or event branding. In commemorative applications, the sculpture may mark milestones such as a golfer's first hole-in-one, tournament victory, or career-best performance.

This embodiment may be extended to other sports as well. For example, it may be adapted to represent the complex movements of a baseball pitch, a tennis serve, or a hockey slapshot. Each sculpture becomes a kinetic artifact—a visually and physically engaging representation of an athlete's defining motion.

By combining motion data, aesthetic form, embedded electronics, and interactivity, this fourth embodiment elevates the sculpture from a static object into a living memory—an elegant fusion of art, technology, and athletic identity.

In additional embodiments, the systems and methods described herein may be adapted to other sports that involve dynamic, three-dimensional motion, such as figure skating, basketball, baseball, and tennis. In each case, the core pipeline remains consistent: motion is captured using video or sensor data; a trajectory or motion path is reconstructed in three dimensions; and a physical sculpture is created by lofting or sweeping cross-sectional profiles along the path.

In one embodiment, the system is configured to capture the path of a figure skater during a choreographed routine. Video footage may be recorded from a stationary rink-side camera, a mobile camera operator, or an aerial drone. The motion of interest may be the skater's center of mass, a specific limb (such as an extended arm), or the tip of a skate blade. In one implementation, the reconstructed path is rendered as a flowing ribbon with varying curvature and width, where sharp spins produce twisted, tightly coiled segments, and long glides result in extended, sweeping arcs.

The resulting sculpture may reflect not only the spatial path but also the rhythm of the performance, with optional integration of lighting to animate the motion in time with music. In competitive applications, the sculpture may commemorate an Olympic or world championship routine and be mounted with engraved metadata such as music selection, score, and performance date.

In another embodiment, the invention is adapted to visualize the trajectory of a basketball during a shot. Video input may be sourced from sideline cameras or overhead arena feeds. The motion of the ball is tracked from the moment it leaves the player's hands until it reaches the hoop. A three-dimensional path is reconstructed using triangulation or depth estimation, and a solid or hollow sculpture is generated along this path.

In some cases, the sculpture includes the player's hand trajectory during the shot, allowing a layered or dual-path representation. Cross-sectional thickness may vary to reflect ball velocity or spin rate. For commemorative applications, the system may be used to create a sculpture of a game-winning shot, complete with team logos, final score, and date etched on the base.

In another embodiment, the invention is configured to model the swing of a baseball bat or the trajectory of a pitch. High-frame-rate video from behind the batter or pitcher is processed to track the relevant object—either the bat or the baseball—and reconstruct its motion in three dimensions. The modeled path may capture nuanced variations in swing arc or pitch movement, such as the lateral break of a slider or the rise of a fastball.

In the batting embodiment, the system generates a sculpture that flares at the point of impact and tapers along the follow-through, highlighting the moment of contact. In the pitching embodiment, a sculpture may visually differentiate pitch types based on trajectory curvature and rotational spin. These artifacts can serve as coaching tools, memorabilia, or training aids.

In yet another embodiment, the system captures and sculpts the motion of a tennis racquet or ball during a serve, forehand, or volley. Video input may be recorded from courtside cameras or smartphones. The system tracks the racquet head and reconstructs its trajectory throughout the stroke. In some implementations, the sculpture includes a variable-width ribbon that widens during acceleration phases and narrows during transitions or deceleration.

Alternatively, the path of a tennis ball over the net may be modeled, with lofting profiles modulated to reflect spin rate or impact velocity. Time-indexed annotations may be engraved or embedded into the sculpture to mark key swing moments such as contact point, apex, or landing. These embodiments are particularly useful in player development settings, allowing coaches and athletes to visualize and preserve the form and fluidity of iconic shots.

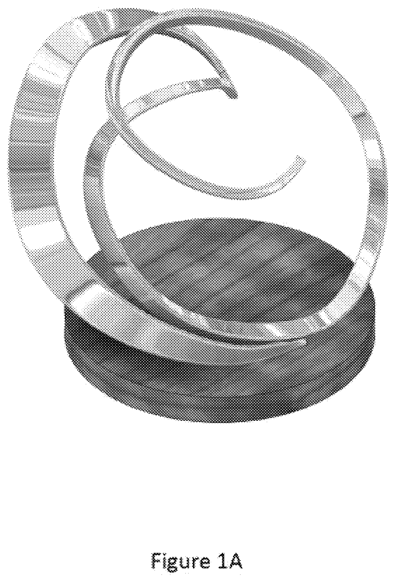

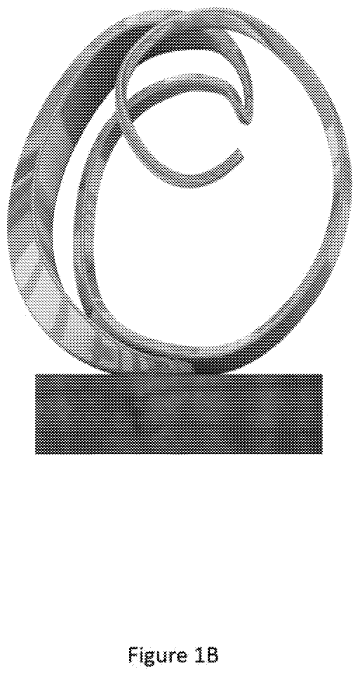

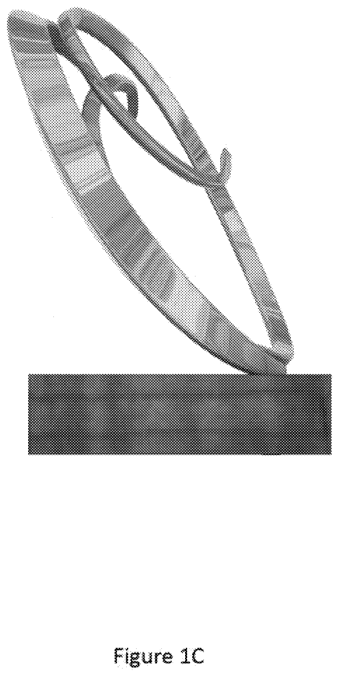

Referring now to the drawings, FIGS. 1A through 1C illustrate an example of a three-dimensional sculpture generated in accordance with one or more embodiments of the present invention.

In further embodiments, the system and methods described herein are adapted to generate three-dimensional swing sculptures in the form of fine jewelry, including pendants, earrings, and rings. Rather than creating a full-size sculpture mounted on a display base, the CAD model of the reconstructed swing path is scaled down significantly and modified with jewelry-specific attachment features.

In one embodiment, the sculpture is converted into a pendant by attaching a small loop or bail to the top of the swing path model, allowing it to be threaded onto a necklace chain. The loop may be designed directly into the CAD model using the same modeling software, such as Fusion 360®, and aligned with the orientation of the swing for optimal presentation. The resulting design preserves the geometric integrity of the original swing while adapting it to function as a wearable object. The miniature sculpture may retain features such as variable-width profiles or flared sections that reflect swing dynamics, now rendered in precious metal.

In another embodiment, the CAD model is adapted to form a pair of earrings. Instead of a loop for a chain, each earring design incorporates a small rod or post extending from one end of the swing path, allowing it to connect to a conventional earring back or hook. The orientation of the post may be adjusted based on how the swing is intended to hang relative to the ear. The earrings may be symmetrical, representing mirrored swing paths, or asymmetrical, representing two different swings (e.g., backswing and follow-through).

In yet another embodiment, the model is scaled and shaped into a ring. In one approach, a section of the swing path is wrapped into a circular or elliptical band to form the ring itself, with no additional features needed. The resulting ring preserves the dynamic, flowing character of the swing while functioning as an elegant and subtle representation of motion.

These jewelry pieces are preferably fabricated using lost-wax casting techniques. In this process, the finalized CAD model is 3D printed in wax, and then a mold is formed around the wax pattern using a plaster-like material. Once cured, molten precious metal—such as gold, silver, or platinum—is poured into the mold, which melts away the wax and fills the resulting cavity. After cooling, the mold is broken away to reveal the metal form, which is then polished and finished using conventional jewelry-making techniques.

This adaptation of the invention expands its scope beyond commemorative sculptures into the domain of wearable, personalized art. Each jewelry piece is derived from a specific swing, serve, or motion unique to the wearer, creating a deeply personal artifact that blends sport, technology, and aesthetics. Such pieces may serve as symbolic keepsakes, gifts, or high-end memorabilia, and may optionally be accompanied by a certificate or digital file verifying the source of the original motion data.

In certain embodiments, the invention provides a system and method for reconstructing a three-dimensional path of an athletic object, such as a golf club head, from a single video source using one or more machine-learning models. Unlike systems that rely on multi-camera triangulation, the present embodiment is configured to infer depth and spatial motion from a monocular video sequence by combining learned visual features, temporal motion analysis, geometric constraints, and trajectory refinement operations. The resulting three-dimensional trajectory may then be used to generate a digital model of a physical sculpture, as described elsewhere herein.

In one implementation, a user captures a video of a golf swing using a smartphone, tablet, action camera, or other monocular image-capture device positioned at a fixed location relative to the golfer. The camera may be positioned in a down-the-line view, a face-on view, an oblique view, or another suitable viewpoint from which at least a portion of the club head motion is visible over time. The video may be recorded locally and processed on the device itself, or transmitted to a remote computing system for further analysis. In some embodiments, the system receives metadata associated with the video, including frame rate, focal length, zoom level, device model, inertial measurement data, exposure settings, and capture orientation, and uses such metadata as additional input for reconstruction or calibration.

In some embodiments, the input video is first subjected to a preprocessing stage. The preprocessing stage may include one or more of video stabilization, lens distortion correction, frame interpolation, frame selection, temporal cropping, background subtraction, golfer segmentation, contrast enhancement, white-balance normalization, or resizing to a model-compatible resolution. In certain implementations, the system identifies a temporal window corresponding to the athletic motion of interest, such as the period beginning before takeaway and ending after follow-through in a golf swing. This temporal window may be identified automatically by a classifier, by motion onset detection, by detection of object acceleration beyond a threshold, or through manual user selection in an application interface.

In some embodiments, the system detects and tracks an object of interest within the monocular video sequence. For a golf application, the object of interest may be the club head, a point on the shaft, the grip end, the club face center, or a plurality of points associated with the golf club. In other embodiments, the object of interest may be a ball, racquet head, bat, skate blade, hand, foot, elbow, center of mass, or other anatomical or sporting implement feature. Detection may be performed using one or more machine-learning object detectors, keypoint detectors, segmentation models, template-matching algorithms, optical-flow techniques, or combinations thereof.

In one implementation, a first neural network processes individual video frames to estimate a two-dimensional location of the club head in each frame. The first neural network may include, by way of example and not limitation, a convolutional neural network, a transformer-based vision model, a heatmap-generating keypoint network, or a detector configured to output one or more bounding boxes, masks, or keypoint coordinates. In some embodiments, the first neural network outputs, for each frame, a confidence score associated with the predicted two-dimensional club-head location. Frames with confidence scores below a threshold may be flagged for interpolation, discarded, or presented to the user for optional correction.

In certain embodiments, the system further generates a temporal sequence of image features corresponding to the object of interest and surrounding scene context. Such features may include local appearance features, silhouette information, object orientation estimates, motion vectors, inter-frame displacement, optical-flow fields, temporal gradients, and contextual information associated with the golfer's body position or the environment. These features may be provided to a second machine-learning model configured to estimate depth or directly infer a three-dimensional trajectory.

In some embodiments, the second machine-learning model receives as input a sequence of frames or frame-derived features and outputs, for each frame or sampled time index, an estimated depth value associated with the object of interest. In this manner, the model may produce a time-indexed sequence of values (u_t, v_t, d_t), where u_t and v_t represent image-plane coordinates and d_t represents estimated depth relative to the camera. In other embodiments, the model directly outputs three-dimensional coordinates (x_t, y_t, z_t) in a camera coordinate system, a world coordinate system, or a normalized reconstruction space. In still further embodiments, the model outputs a latent representation of the motion, from which a downstream module reconstructs a continuous three-dimensional trajectory.

The second machine-learning model may be configured in various ways. In some implementations, the model is a temporal convolutional neural network that receives a stack of frame features and predicts depth values over a plurality of time steps. In other implementations, the model includes a recurrent neural network, long short-term memory network, gated recurrent unit network, temporal transformer, graph neural network, or hybrid architecture combining spatial feature extraction with temporal sequence modeling. In certain embodiments, the model is trained to enforce temporal coherence, so that adjacent outputs vary smoothly unless image evidence suggests abrupt motion. In some embodiments, the model jointly estimates depth, confidence, velocity, and/or uncertainty for each predicted point along the trajectory.

In one example, the machine-learning pipeline includes: (i) a frame-level detector for estimating a two-dimensional club-head point; (ii) a temporal encoder that aggregates image and motion features over a plurality of sequential frames; and (iii) a trajectory decoder that predicts a sequence of three-dimensional coordinates corresponding to the club head path over time. In some implementations, the trajectory decoder outputs coordinates at the native frame rate of the video. In other implementations, the decoder outputs a fixed number of points, such as 32, 50, 75, 100, or 150 points, spaced uniformly in time or arc length along the motion.

In certain embodiments, the system is trained using supervised data. For example, training data may include synchronized monocular video and reference three-dimensional motion data obtained from multi-camera motion capture systems, launch-monitor data, structured-light scanners, inertial sensors, radar systems, lidar systems, manually labeled 3D reconstructions, or combinations thereof. In some embodiments, the reference three-dimensional motion data is represented as point trajectories, spline control points, depth maps, or pose sequences. The learning objective may include one or more losses based on Euclidean point error, trajectory smoothness, temporal consistency, depth-ranking accuracy, projection consistency, velocity consistency, acceleration regularization, or event alignment.

In other embodiments, the system is trained using weak supervision, self-supervision, semi-supervision, or synthetic data. By way of example, a synthetic data generation pipeline may render simulated golf swings or other athletic motions from known three-dimensional models and camera parameters to create large volumes of monocular training footage with corresponding ground-truth depth and trajectory labels. In some implementations, synthetic training data is augmented with domain-randomized backgrounds, lighting conditions, clothing variations, club geometries, body types, and camera poses to improve robustness to real-world consumer videos. In some embodiments, self-supervised training uses projection consistency, whereby a predicted three-dimensional trajectory, when reprojected into the image plane under estimated or known camera parameters, is compared against observed two-dimensional detections or segmentation masks. This permits model refinement even in the absence of full ground-truth three-dimensional labels.

In certain embodiments, the system estimates or receives camera parameters for converting model outputs into a physically meaningful three-dimensional coordinate system. Camera parameters may include intrinsic parameters, such as focal length, principal point, skew, and lens distortion coefficients, and extrinsic parameters, such as position, tilt, yaw, roll, and relative orientation to a ground plane. In some implementations, the camera parameters are estimated from the video itself using vanishing lines, scene geometry, known reference dimensions, fiducial markers, device metadata, detected body proportions, club length, or estimated ground-plane relationships. In other embodiments, the system reconstructs the trajectory in a normalized coordinate space and later scales or orients the trajectory using one or more known dimensions, such as the length of a golf club, height of the golfer, position of the golf ball, or distance between detected stance points.

In some embodiments, the machine-learning model estimates depth on a per-frame basis. In such embodiments, a depth value is predicted independently or semi-independently for each detected two-dimensional object location, and the sequence of depth values is then combined with image-plane coordinates to obtain a frame-wise set of three-dimensional points. In other embodiments, depth is inferred at a trajectory level rather than strictly frame by frame. For example, the system may process an entire swing segment and output a temporally coherent three-dimensional path constrained by learned priors regarding typical swing mechanics, continuity of motion, and expected club-head arc. Trajectory-level inference may reduce jitter and improve robustness where the club head is partially occluded or blurred.

In certain embodiments, the system determines one or more swing events from the monocular video and uses such events to improve temporal alignment and reconstruction quality. Such events may include address, takeaway, shaft-parallel, top of backswing, transition, impact, early follow-through, finish, or other user-defined or sport-specific events. Event timing may be inferred by a classifier, by velocity extrema, by body-pose transitions, by club orientation changes, or by manual input. In some implementations, event timing is used to normalize the trajectory to a canonical temporal coordinate system so that the output trajectory includes corresponding samples at consistent motion phases across users. This facilitates downstream comparison between different swings and enables consistent modulation of sculpture geometry based on analogous motion intervals.

In some embodiments, the system includes a confidence-filtering stage. The confidence-filtering stage may evaluate the reliability of each predicted two-dimensional or three-dimensional point based on detector confidence, motion blur, occlusion likelihood, disagreement between multiple model heads, trajectory curvature anomalies, temporal discontinuities, or uncertainty estimates produced by the model. Points below a confidence threshold may be replaced by interpolated values, smoothed using neighboring estimates, or marked for optional user confirmation. In some embodiments, the system employs a robust estimator, Kalman filter, particle filter, Savitzky-Golay filter, spline-fitting process, moving-average filter, Gaussian process regression, or optimization-based smoothing routine to refine the raw predicted path.

In one implementation, the system fits a parametric curve, spline, Bezier path, NURBS curve, polynomial approximation, or piecewise smooth centerline to the predicted three-dimensional points. The fitted curve may preserve event points or high-curvature segments while suppressing noise and frame-to-frame jitter. In some embodiments, the system resamples the fitted curve to generate a desired number of time-indexed or arc-length-indexed points suitable for downstream CAD modeling. The resampled points may be evenly spaced, adaptively spaced based on curvature, or aligned with detected swing events.

In certain embodiments, the system further derives motion attributes from the reconstructed three-dimensional path. Such motion attributes may include instantaneous speed, acceleration, jerk, curvature, torsion, direction change, angular velocity, angular acceleration, tempo, transition smoothness, point of maximum speed, impact orientation, path symmetry, or deviation from a reference trajectory. These motion attributes may be stored in association with corresponding positions along the path and later used to influence geometry generation for the sculpture. For example, sections of the path associated with increased speed may be assigned increased thickness, twist, flare, transparency, color differentiation, texture, rib spacing, or other manufacturable geometric or visual features.

In some embodiments, the system provides an interactive review interface prior to committing the reconstructed path for fabrication. The interface may display a three-dimensional rendering of the predicted trajectory, optionally together with the original video, projected two-dimensional detections, time-indexed markers, uncertainty indicators, and event labels. A user may rotate, zoom, scrub through time, or inspect the path from multiple viewpoints. In certain implementations, the user may adjust one or more trajectory points, designate correction anchors, confirm or reject portions of the path, or request automatic reprocessing under a different model configuration. User corrections may be incorporated into a subsequent optimization stage or may be used to fine-tune one or more model outputs for the particular swing under consideration.

In some embodiments, multiple machine-learning models are used in an ensemble arrangement. For example, a first model may be optimized for high-speed segments near impact, while a second model may be optimized for lower-speed segments such as takeaway or finish. In other embodiments, a first model may estimate body pose and club orientation, while a second model uses such information to infer the three-dimensional club-head trajectory. In some implementations, the system compares outputs from multiple models and selects, averages, or fuses the outputs according to confidence, sport type, camera viewpoint, or video quality metrics.

In certain embodiments, the system is adapted to perform domain-specific reconstruction for different sports or motions. For a tennis serve, the model may be trained to track a racquet head and optionally a ball toss. For baseball, the model may reconstruct a bat trajectory or a pitched ball trajectory. For basketball, the model may track a ball path and shooting-hand motion. For figure skating, the model may track a skate blade or body centerline. In such embodiments, the system may select a sport-specific model architecture, training corpus, event taxonomy, or post-processing constraint based on user input or automatic classification of the athletic activity.

In some embodiments, the system stores the final reconstructed trajectory as a structured data object, such as a table, point cloud, polyline, spline control-point list, CSV file, JSON object, XML file, or proprietary geometry format. The stored data may include not only coordinates, but also timestamps, confidence values, event labels, derived motion metrics, camera metadata, user edits, and version information associated with the reconstruction pipeline. This enriched data representation may be used to generate the final sculpture, reproduce the reconstruction later, compare swings over time, or generate derivative products such as visualizations, jewelry, or interactive display artifacts.

In one illustrative implementation, the reconstruction pipeline proceeds as follows. A smartphone video of a golf swing is captured from a down-the-line viewpoint. A frame-selection module extracts a sequence of frames spanning the full swing motion. A detection model estimates the club-head position in each frame and produces frame-level confidence values. A temporal depth-estimation model processes the sequence of detected positions, optical-flow information, and image features to estimate a three-dimensional club-head path in a camera-centered coordinate system. A trajectory-refinement module removes outliers, fills low-confidence gaps, smooths the path, and identifies motion events including takeaway, top of backswing, impact, and finish. A resampling module generates a fixed sequence of points along the path, together with local speed and curvature metrics. The resulting trajectory data is then exported to a computer-aided design environment, where a centerline is generated and used to define the physical sculpture.

In some embodiments, the model is configured to infer absolute scale. In other embodiments, the model infers relative three-dimensional shape, and a scaling module subsequently converts the shape to a desired physical size based on known reference values, such as club length or user-entered dimensions. In some implementations, the scaling module also normalizes the trajectory for manufacturability, such as by enforcing minimum wall thickness, minimum bend radii, or base-interface constraints.

In certain embodiments, the system includes failure-detection logic. If the object of interest is occluded for more than a threshold duration, if image quality falls below a threshold, if the predicted trajectory violates plausibility constraints, or if uncertainty exceeds a threshold, the system may notify the user, request another capture, prompt for manual correction, or switch to a fallback reconstruction mode. The fallback reconstruction mode may include greater reliance on user-marked points, geometric assumptions, body-pose cues, or a lower-complexity model.

In some embodiments, the machine-learning reconstruction pipeline is continuously improved over time. With appropriate user permission, videos, corrections, and confirmed trajectories may be added to a training or validation corpus to refine the detection and reconstruction models. In this manner, the system may become increasingly accurate across different golfers, skill levels, capture environments, club types, lighting conditions, and camera placements.

The foregoing monocular machine-learning embodiment advantageously enables the generation of a three-dimensional motion-derived sculpture from a single consumer-captured video while reducing or eliminating the need for a second synchronized camera. By leveraging learned priors, temporal sequence modeling, uncertainty handling, and trajectory refinement, the system can provide a sufficiently accurate and aesthetically useful reconstruction for fabrication of a personalized physical artifact.

In certain embodiments, the invention provides a system and method for generating a three-dimensional reconstruction of an athletic motion from a single video source using camera calibration, scene reference information, motion constraints, and trajectory estimation. In contrast to embodiments relying on synchronized multi-camera triangulation, the present embodiment uses a monocular video together with known or estimated geometric reference information to infer a three-dimensional path of an athletic object, such as a golf club head, tennis racquet head, baseball bat, hockey stick blade, ball, or other moving feature of interest. The reconstructed path may then be used to generate a physical sculpture, model, display object, wearable item, or interactive artifact, as described elsewhere herein.

In one implementation, a user captures a video of a golf swing using a single camera positioned at a generally fixed location relative to the golfer. The camera may be a smartphone, tablet, action camera, webcam, digital camera, or other image-capture device. The camera may be placed in a down-the-line orientation, a face-on orientation, an oblique orientation, or another viewpoint from which the motion of the club head is at least partially visible throughout the swing. The camera may be mounted on a tripod, attached to a support fixture, or otherwise positioned in a substantially stationary manner during recording. In some embodiments, the system is configured to tolerate small amounts of camera shake or drift by performing digital stabilization prior to reconstruction.

In some embodiments, the recorded scene includes one or more calibration references from which camera parameters and spatial relationships may be determined. The calibration reference may include a checkerboard pattern, ArUco marker, AprilTag, Charuco board, fiducial grid, line-marked pole, calibration wand, reference cube, planar target, reference mat, alignment strip, or another object having known dimensions, geometry, spacing, orientation, or appearance. In certain embodiments, the calibration reference is placed on the ground near the golfer, behind the golfer, beside the hitting area, or in another region visible to the camera during at least a portion of the recording. In other embodiments, naturally occurring scene features of known geometry, such as mat boundaries, flooring seams, tee markers, alignment sticks, target lines, or architectural edges, are used in addition to or instead of a dedicated calibration target.

In certain implementations, the system performs a camera calibration stage to estimate intrinsic camera parameters. Such intrinsic parameters may include focal length, principal point, aspect ratio, skew, and one or more lens-distortion coefficients. In some embodiments, these values are estimated from images of the calibration reference captured before, during, or after the swing. In other embodiments, intrinsic values are obtained from stored device profiles, imaging metadata, or previously saved calibration data associated with the capture device. In still further embodiments, intrinsic parameters are refined iteratively based on reprojection consistency between observed image features and estimated three-dimensional scene geometry.

In some embodiments, the system also estimates extrinsic camera parameters, including one or more of camera position, pitch, yaw, roll, tilt relative to a ground plane, and distance relative to a hitting area or subject location. Extrinsic parameters may be derived from the observed pose of a calibration target, from detected vanishing lines, from a known ground-plane reference, from known object dimensions such as club length or mat dimensions, or from body-pose information associated with the athlete. In some implementations, the system constructs a camera coordinate system and a world coordinate system, and determines a transformation between them so that reconstructed path points can be expressed in a common, physically interpretable frame.

In certain embodiments, the system identifies a reference plane associated with the athletic motion. In a golf implementation, the reference plane may correspond to a ground plane, a hitting mat plane, a stance plane, a ball plane, a target line plane, a swing plane, or a combination thereof. The reference plane may be estimated from the calibration target, from visible planar scene geometry, from body-pose landmarks such as foot positions, or from known equipment placement such as ball location and target alignment. In some embodiments, use of a reference plane constrains the reconstruction and reduces ambiguity inherent in monocular depth estimation.

In some implementations, the system detects and tracks an object of interest in the video. For golf, the object of interest may be the club head, the hosel, the center of the club face, a marker affixed to the club head, the shaft tip, or a representative point associated with the club. Tracking may be manual, semi-automatic, or automatic. Automatic tracking may include object detection, keypoint detection, template matching, optical flow, segmentation, edge tracking, motion contour extraction, or combinations thereof. In some embodiments, the system associates each tracked point with a confidence score indicating detection reliability.

In certain embodiments, the system processes the monocular video frame by frame to determine a sequence of image-plane coordinates corresponding to the detected object of interest over time. These coordinates may be represented as pixel positions, normalized image coordinates, or rays extending from the camera center through the image plane into three-dimensional space. Because a monocular image generally defines a line of sight rather than a unique depth, the system uses one or more additional constraints to estimate the corresponding three-dimensional position along each line of sight.

In one embodiment, the system reconstructs the three-dimensional path by intersecting or approximating the detected image rays with one or more estimated constraint surfaces. Such constraint surfaces may include a ground-offset surface, a swing envelope, a body-relative kinematic region, a club-length-constrained locus, a motion continuity surface, or a phase-specific height model. For example, during portions of a golf swing near address or impact, the club head may be constrained to lie within a bounded height range relative to the ground plane and within a bounded radial distance relative to the golfer's hands, ball position, or club grip position. During backswing and follow-through, the club head may be constrained to follow a smooth arc consistent with club length, rotational motion, and previously estimated path segments.

In some embodiments, the system uses a club-length constraint. More particularly, the system may detect or estimate a grip location, hand location, or wrist location, and may further estimate a shaft direction or club orientation. Because the club head is physically connected to the hands by a substantially fixed-length shaft, the system may restrict possible three-dimensional club-head positions to those lying at or near a distance corresponding to the known or estimated club length from a detected hand-related reference point. In some implementations, the intersection of a line-of-sight ray from the camera and a club-length-constrained spherical or circular locus yields one or more candidate three-dimensional positions, from which the system selects a position based on temporal continuity, expected swing direction, or phase-specific plausibility.

In certain embodiments, the system uses body-pose information as a reconstruction aid. The system may detect one or more anatomical landmarks of the golfer, including shoulders, elbows, wrists, hands, hips, knees, ankles, and feet. A body-pose model may be used to estimate the approximate position of the hands and arms over time, thereby constraining likely club-head motion relative to the golfer's body. In some implementations, the system assumes the club head follows a kinematic chain anchored at the hands or wrists and uses inverse kinematics, forward kinematics, or heuristic swing models to reduce monocular ambiguity. For example, if the hand position and approximate club orientation are known, the set of feasible club-head positions may be substantially narrowed.

In some embodiments, the system divides the athletic motion into phases and applies different reconstruction constraints to different phases. In a golf swing, such phases may include address, takeaway, early backswing, mid-backswing, top of backswing, transition, early downswing, late downswing, impact, early follow-through, and finish. During address and impact, the club head may be constrained relative to the ground plane, ball position, or a known impact zone. During mid-backswing and follow-through, the club head may be permitted greater vertical excursion but remain constrained by club-length continuity, body-pose relationships, and smooth angular motion. In some embodiments, phase-specific reconstruction reduces error by avoiding a single overly generalized assumption about the entire swing.

In one implementation, the system uses a phase-dependent height model rather than assuming that the club head remains at a single predictable height. The height model may define one or more permissible ranges, envelopes, or priors for vertical position as a function of swing phase, hand position, club orientation, body rotation, or inferred path curvature. For example, the system may allow the club head to rise during the backswing, descend toward the impact region, and rise again during follow-through, while still constraining the path to a smooth and physically plausible three-dimensional arc. In this manner, the reconstruction may be more robust and more defensible than a simplistic constant-height approximation.

In certain embodiments, the system uses event detection to anchor the reconstruction. The system may identify one or more key events, such as address, takeaway, top of backswing, impact, and finish. These events may be inferred from the tracked image path, from club-speed changes, from pose transitions, from manual user input, or from combinations thereof. One or more of these events may be associated with known or estimated spatial conditions. For instance, at impact the club head may be assumed to pass through an impact zone proximate a known ball location and at or near a ground-referenced elevation. At address, the club head may be associated with a setup location relative to the golfer's stance and ball position. These anchor events may be used to initialize or regularize the overall three-dimensional trajectory estimation.

In some embodiments, the system determines a ball location, target line, or impact zone from the image. The ball location may be manually specified by the user, detected automatically, or inferred from known placement on a hitting mat. The target line may be estimated from alignment aids, target markers, or ground-plane geometry. These references may define a local coordinate system around the strike area and may be used to constrain where the club head is likely to pass during impact or near-impact frames. In some implementations, the known or estimated impact zone acts as an anchor that helps disambiguate depth and orientation for neighboring trajectory segments.

In certain implementations, the system formulates reconstruction as an optimization problem. A set of candidate three-dimensional points is estimated for the tracked object over a sequence of frames, and an objective function is minimized or otherwise optimized subject to one or more constraints. The objective function may include terms representing reprojection consistency, temporal smoothness, bounded acceleration, bounded jerk, club-length preservation, event-anchor satisfaction, phase-specific plausibility, body-relative kinematic consistency, and adherence to known scene geometry. The resulting optimized trajectory may be represented as a discrete point set, spline, parametric curve, NURBS path, or other continuous three-dimensional representation.

In some embodiments, reprojection consistency is used to evaluate or refine the estimated path. More particularly, a candidate three-dimensional trajectory is projected back into the image plane using the estimated camera parameters, and the projected two-dimensional positions are compared against observed tracked positions, segmentation masks, motion contours, or optical-flow information. A correction stage may iteratively adjust the three-dimensional path to reduce reprojection error while maintaining smoothness and compliance with kinematic or geometric constraints. This reprojection-based refinement may improve accuracy even where the initial monocular estimate is approximate.

In one embodiment, the system estimates a three-dimensional path using a first-pass geometric solution and then applies a trajectory refinement stage. The first-pass solution may determine coarse depth values by intersecting image rays with a reference plane offset, with a club-length-constrained surface, or with a learned or predefined swing envelope. The refinement stage may then modify the coarse path using spline fitting, curvature regularization, event alignment, pose consistency, or iterative reprojection minimization. In some embodiments, the first-pass solution yields a practical initialization, while the refinement stage provides a smoother and more physically plausible final trajectory suitable for manufacturing.

In certain embodiments, the system uses multiple candidate models and selects among them. For example, a first candidate path may be generated under a ground-plane-dominant constraint, a second candidate path may be generated under a club-length-dominant constraint, and a third candidate path may be generated under a body-pose-dominant constraint. A scoring module may evaluate these candidate paths based on reprojection error, smoothness, event consistency, or expected swing mechanics, and may select or blend one or more candidate paths to form the final trajectory. This multi-hypothesis approach may be particularly useful when portions of the club head path are blurred, occluded, or poorly resolved.

In some embodiments, the system accounts for occlusion and temporary tracking loss. If the club head is obscured by the golfer's body, the ground, motion blur, or environmental clutter during one or more frames, the system may interpolate through the obscured interval using neighboring reconstructed segments, estimated body motion, club-length continuity, or event constraints. In some implementations, missing segments are reconstructed by fitting a smooth curve between higher-confidence portions of the path, subject to bounds on velocity, acceleration, curvature, and angular progression. Such interpolation may preserve manufacturable continuity while maintaining fidelity to the captured motion.

In certain embodiments, the system estimates uncertainty associated with each reconstructed point or segment. Uncertainty may be derived from image quality, detector confidence, calibration quality, constraint disagreement, or sensitivity of the optimized solution. Points or segments associated with higher uncertainty may be smoothed more aggressively, flagged for optional user review, or rendered differently in downstream visualization tools. In some embodiments, a user interface displays uncertainty bands, confidence markers, or highlighted segments so that the user may approve, edit, or recapture the motion if desired.

In some embodiments, the reconstructed path is represented in a world coordinate system tied to the scene. For example, the system may define axes corresponding to target-line direction, horizontal cross-target direction, and vertical direction relative to the ground plane. In other embodiments, the path is represented in a body-relative coordinate system tied to the golfer, such as a stance-centered frame or shoulder-aligned frame. In further embodiments, both representations are stored, allowing the sculpture-generation stage to emphasize either absolute motion in the scene or relative motion normalized to the athlete's body.

In some implementations, the system normalizes the reconstructed path before downstream modeling. Normalization may include translation to a common origin, rotation to align with a target axis, scaling to reflect club length or desired sculpture size, temporal resampling, arc-length resampling, smoothing, or coordinate-system conversion. In one embodiment, the system resamples the path to a fixed number of points, such as 50, 75, 100, or another suitable number, to simplify subsequent modeling in a CAD environment. In another embodiment, point density varies with curvature, event importance, or local trajectory complexity.

In certain embodiments, the system derives secondary motion attributes from the calibrated monocular reconstruction. Such attributes may include club-head speed, acceleration, tempo, transition timing, path curvature, path torsion, vertical excursion, lateral deviation, approach angle, release characteristics, or relative position at one or more key swing events. These attributes may be used not only for analysis, but also for geometry generation. For example, path segments associated with greater speed may be rendered with increased thickness, sharper faceting, greater twist, wider ribbon flare, denser ribbing, or another geometric modulation in the final sculpture. Segments associated with transition or impact may be marked by localized geometric accents, material changes, embedded structures, or time-indexed decorative features.

In one illustrative implementation, a user places a calibration mat behind the golf ball, the mat including a printed fiducial grid and alignment lines of known dimensions. The user records a golf swing from a down-the-line viewpoint with a smartphone supported on a tripod. The system detects the fiducial grid and alignment lines to estimate camera intrinsics, camera pose, and a ground-plane reference. The system further detects the golfer's body pose and tracks the club head frame by frame. For each frame, the system computes a line of sight from the calibrated camera through the tracked club-head image position. The system then estimates a corresponding three-dimensional club-head point by selecting a location along the line of sight that satisfies one or more applicable constraints, including club-length consistency relative to estimated hand position, phase-specific height bounds, temporal continuity with neighboring frames, and proximity to one or more event anchors such as address or impact. Once a sequence of candidate three-dimensional points has been estimated, the system fits a smooth spline through the points, minimizes reprojection error, identifies key swing events, and exports the refined trajectory for use in generating a physical sculpture.

In some embodiments, the calibration target need not remain continuously visible throughout the full swing. For example, the target may be detected in one or more initialization frames prior to or during the swing, after which the estimated camera parameters and ground-plane reference are maintained for subsequent reconstruction. In other embodiments, a portable calibration object may be shown briefly to the camera and then removed from the scene before the actual athletic motion is recorded. In still further embodiments, calibration data may be pre-stored for a dedicated capture station or repeated practice environment, thereby eliminating the need to place a fresh target for each recording session.

In certain embodiments, the system supports user-assisted calibration or reconstruction. A user may mark one or more points corresponding to ball position, club position at address, impact location, target line, ground line, or dimensions of a visible reference object. Such user input may be used to initialize, refine, or validate the calibration and path-estimation process. In some implementations, the user may also correct segments of the tracked two-dimensional path or approve an automatically generated three-dimensional reconstruction before fabrication.

In some embodiments, the system includes plausibility rules specific to the equipment being tracked. For example, the expected club length, club-head size, shaft straightness, grip location, and handedness of the golfer may influence reconstruction. A right-handed and left-handed swing may be treated differently with respect to path orientation and event ordering. Different club types, such as driver, iron, wedge, putter, or training aid, may have different expected lengths and motion envelopes. These equipment-specific rules may improve reconstruction accuracy and may provide additional basis for downstream customization of the resulting sculpture.

In certain embodiments, the system uses a library of reference motions or motion priors. A reconstructed path may be compared against one or more stored examples corresponding to known or archetypal athletic motions. The system may use such priors to regularize the path, disambiguate candidate depth solutions, or score whether a reconstructed path is physically plausible. In some implementations, the reference-motion library is personalized to a particular user, so that subsequent monocular reconstructions can benefit from prior captures of that same athlete. In other implementations, the library is aggregated from many users and indexed by skill level, sport type, handedness, club type, camera viewpoint, or other metadata.

In some embodiments, the system may transition between purely geometric reconstruction and learned-assisted reconstruction. For example, a calibrated geometric engine may generate an initial path, and a learned model may adjust portions of that path based on prior motion statistics. Conversely, a learned monocular estimator may generate an initial path, after which a calibrated geometric engine enforces scene consistency, club-length constraints, and event anchors. Such hybrid approaches are expressly contemplated and may be used to improve robustness across varied capture conditions.

In certain embodiments, the final reconstructed path is stored as enriched trajectory data, which may include three-dimensional coordinates, timestamps, event labels, confidence values, applied constraints, calibration parameters, equipment metadata, body-pose references, and user edits. This enriched representation may be passed to a CAD engine or modeling engine, which generates a manufacturable three-dimensional body along the path using sweep, loft, extrusion, ribbing, thickening, shelling, faceting, or other geometric operations. The resulting body may then be fabricated as a sculpture, jewelry piece, display object, instructional aid, or collectible artifact.

The foregoing calibrated monocular embodiment advantageously allows a user to generate a three-dimensional reconstruction of an athletic motion from a single consumer-grade video source without requiring synchronized multi-camera capture. By combining camera calibration, scene geometry, event anchoring, kinematic constraints, continuity assumptions, and optional user input, the system may produce a physically plausible and aesthetically meaningful three-dimensional trajectory suitable for downstream modeling and fabrication.

In certain embodiments, the invention provides an interactive system configured to convert a reconstructed athletic motion into a multi-sensory physical artifact that not only statically represents the motion path, but also dynamically replays one or more aspects of the captured motion through illumination, haptic output, sensing, sound, and user-selectable playback modes. In such embodiments, a physical sculpture generated from a reconstructed three-dimensional motion path is communicatively coupled to an electronic control system that causes one or more output devices associated with the sculpture and/or a support base to present a time-varying representation of the underlying athletic motion. The resulting object functions as a commemorative display, instructional device, conversation piece, or personalized kinetic artwork.

In one implementation, the physical sculpture is formed along a three-dimensional path corresponding to the motion of an athletic object, such as a golf club head, baseball bat, tennis racquet, hockey stick blade, basketball, or a body-derived motion point. The sculpture may be formed as a tube, ribbon, prism, shell, channel, lattice, or another elongate body extending along the reconstructed trajectory. In certain embodiments, at least a portion of the body is formed from a translucent or semi-translucent material, such as clear resin, frosted polymer, glass-like composite, or another light-transmitting structure, so that internally generated light can propagate through the body and visually trace the motion path. In other embodiments, the body is metallic or opaque and includes one or more light windows, perforations, edge channels, embedded light pipes, etched regions, or surface treatments configured to reveal a moving pattern of light corresponding to progression through the underlying motion.

In some embodiments, the system includes a display base configured to mechanically support the sculpture and to house electronic components used for sensing, control, power management, communications, and output generation. The base may be formed from wood, metal, polymer, composite, stone, or layered materials, and may include an internal cavity, frame, cartridge, tray, or modular enclosure configured to receive one or more printed circuit boards, batteries, speakers, vibration motors, cables, charging components, sensors, and control modules. In certain embodiments, the base includes a mounting interface aligned to the reconstructed motion geometry, such as a threaded receptacle, keyed slot, press-fit socket, magnetic coupling, bayonet feature, or concealed fastener arrangement. The mounting interface may position the sculpture at an angle corresponding to the orientation of the reconstructed trajectory in physical space.

In certain embodiments, the interactive system includes a control subsystem comprising a processor and a memory storing instructions executable to replay the captured motion through one or more output channels. The processor may be a microcontroller, system-on-chip, embedded processor, programmable logic device, single-board computer, or another electronic control unit. The memory may store motion data, event markers, playback parameters, user preferences, wireless pairing information, lighting programs, firmware, and one or more lookup tables mapping reconstructed motion states to corresponding output states. In some implementations, the control subsystem is physically contained within the base. In other implementations, part of the control subsystem is contained in the base and part is contained in or along the sculpture body itself, for example in a narrow electronics cavity, a flex circuit routed through the sculpture, or a detachable smart connector.

In some embodiments, the system stores a digital representation of the reconstructed athletic motion in a playback data structure. The playback data structure may include a sequence of three-dimensional coordinates corresponding to successive points along the motion path, together with associated timestamps or normalized time values. In certain implementations, each stored point or segment further includes one or more motion-derived attributes, such as speed, acceleration, curvature, torsion, jerk, event classification, impact likelihood, transition timing, local orientation, swing phase, confidence value, or user-defined annotations. In one example, the playback data structure includes an ordered array of samples, each sample including: (i) a position value; (ii) a temporal index; (iii) a derived intensity value; and (iv) an event flag identifying whether the sample corresponds to address, takeaway, top of backswing, transition, impact, follow-through, finish, or another designated event. In some embodiments, the playback data structure also includes a mapping from path position to a corresponding subset of light emitters embedded within the sculpture.

In certain embodiments, the system generates a path-to-output mapping so that progression through the stored motion path can be visually or physically replayed. For example, the sculpture may include a plurality of addressable light-emitting elements arranged linearly, quasi-linearly, or segment-wise along the interior or exterior of the sculpture body. The addressable light-emitting elements may include LEDs, micro-LEDs, OLED segments, electroluminescent elements, fiber-optic terminations, side-glow fiber segments, or other light-producing structures. A mapping table may associate each reconstructed trajectory point, parametric position, or arc-length interval with one or more corresponding light-emitting elements. During playback, the control subsystem may activate the mapped light-emitting elements in temporal sequence so that a pulse, moving highlight, color gradient, expanding wavefront, fading trail, or other dynamic illumination pattern appears to travel through the sculpture in a manner corresponding to the original athletic motion.

In some embodiments, the system does not require a one-to-one correspondence between stored trajectory points and individual light emitters. Instead, the system may interpolate between stored motion samples and distribute brightness values over multiple neighboring emitters to simulate continuous motion along a discretized lighting array. In one implementation, a continuous path coordinate is computed at each playback time, and the nearest two or more light segments are driven at weighted intensities according to their distance from the computed path coordinate, thereby producing a smooth apparent motion even where the number of physical emitters is limited. In other embodiments, individual sections of the sculpture correspond to motion phases rather than exact point samples, and a segment-based lighting program animates within each section according to the relative timing of the corresponding phase.

In certain embodiments, brightness, color, pulse width, fade rate, and/or spatial spread of illumination are modulated based on motion-derived attributes of the reconstructed path. For example, sections associated with higher club-head speed may be illuminated with increased brightness, extended flare length, higher pulse velocity, denser sparkle effects, or a change in hue. Sections associated with transition may be rendered with a temporary pause, a color inversion, a breathing light pattern, or a localized haptic cue. Impact may be represented by a brief light burst, a concentrated flash, a simultaneous base vibration, an audible sound effect, or a combination thereof. Follow-through may be represented by a dissipating tail of light, a cascading series of pulses, or a delayed secondary glow.

In some embodiments, the system further includes one or more haptic output devices configured to provide tactile feedback synchronized with the stored motion. The haptic output device may include an eccentric rotating mass motor, linear resonant actuator, voice coil actuator, solenoid, piezoelectric element, vibrotactile transducer, or another device capable of producing a perceivable tactile output. One or more haptic output devices may be located within the base, within a plinth or pedestal supporting the base, in a detachable accessory, or in a wearable companion device. In certain embodiments, a first haptic output corresponds to a transition event, a second haptic output corresponds to impact, and a third haptic output corresponds to finish. In other embodiments, the amplitude, frequency, duration, or waveform of the haptic output varies continuously as a function of reconstructed speed, acceleration, event confidence, or another metric derived from the motion data.

In certain implementations, the haptic subsystem uses an event schedule generated from the reconstructed motion data. The event schedule may identify one or more event times, event magnitudes, event types, and event-specific output instructions. For example, an impact event may trigger a sharp, short-duration vibration pulse, while a top-of-backswing event may trigger a softer, delayed double pulse. In some embodiments, the event schedule is generated automatically based on detected extrema or labeled events within the underlying motion data. In other embodiments, event times are manually set, refined by a user, or derived from associated audio or video synchronization markers.

In some embodiments, the system includes an audio subsystem. The audio subsystem may include a miniature speaker, transducer, resonant plate, audio jack, wireless audio output module, or another sound-producing component. The control subsystem may output one or more sounds associated with the stored athletic motion, such as a club strike sound, crowd cheer, spoken annotation, countdown, metronomic cue, coaching note, or ambient soundtrack. In certain embodiments, the audio output is synchronized with visual and haptic playback so that impact, transition, or finish are represented by coordinated multi-modal outputs. In some implementations, a user may select between silent, instructional, commemorative, or ambient playback modes.

In some embodiments, the system includes one or more sensors configured to detect user presence, proximity, touch, gesture, motion, ambient light, ambient sound, base movement, orientation, or another environmental or user-related condition. The sensor may include a capacitive touch sensor, force sensor, pressure switch, hall sensor, inertial measurement unit, passive infrared sensor, ultrasonic distance sensor, optical proximity sensor, camera, microphone, ambient light sensor, or another detection component. In certain embodiments, a playback sequence is automatically initiated when a user approaches within a threshold distance of the sculpture, places a hand on the base, taps the base a predetermined number of times, lifts the object, or performs a recognized gesture. In other embodiments, sensed conditions determine which playback mode is invoked, such as a brief demo mode when a person walks by and a full replay mode when the base is touched for a threshold duration.

In one implementation, the system includes a proximity-triggered idle mode. During idle mode, the sculpture may remain unlit or softly illuminated. When a user enters a threshold range detected by a proximity sensor, the control subsystem may transition to an attention state and illuminate a small portion of the sculpture, the base logo, or a starting marker. If the user remains present or interacts further, the control subsystem may then initiate a full motion playback program in which light travels through the sculpture, haptics are produced at designated events, and optional sound is played. After completion, the system may return to idle mode, a low-power mode, or an attract mode displaying a slow ambient animation.

In certain embodiments, playback timing is based on absolute timestamps derived from the reconstructed motion, so that the replay substantially matches the original tempo of the athletic movement. In other embodiments, playback timing is based on normalized time and may be stretched, compressed, looped, reversed, segmented, or otherwise transformed for visual effect or instructional value. For example, a slow-motion mode may preserve the relative timing between events while extending overall duration; a comparison mode may interleave two different swings at matched event boundaries; and a highlight mode may skip low-interest portions and emphasize impact and follow-through. In some embodiments, the system allows the user to select a playback speed multiplier, such as 0.25×, 0.5×, 1×, 2×, or a user-defined value.

In certain embodiments, the control subsystem generates playback frames from the stored data structure. Each playback frame may include one or more light-output values, haptic-command values, audio-command values, and timing parameters. Playback frames may be generated in real time or precomputed and stored in memory. In one implementation, a scheduler executes playback frames according to a timing queue, wherein each queue entry contains a target time and corresponding actuator commands. In another implementation, the control subsystem evaluates the current playback time continuously and computes output values by interpolation between adjacent motion samples. This permits smooth animation even where the underlying motion data is sampled at a lower rate than the light-control loop.

In some embodiments, the interactive sculpture supports multiple concurrent playback layers. A first layer may correspond to a primary moving light pulse representing the path of the athletic object. A second layer may correspond to a trailing glow representing elapsed motion. A third layer may correspond to event markers, such as brief flashes at impact or transition. A fourth layer may correspond to user-selected thematic styling, such as team colors, tournament branding, or a celebratory pattern. The control subsystem may composite or otherwise combine these layers to produce a richer visual presentation. In certain implementations, layers are prioritized or alpha-blended so that one effect may override or augment another.

In some embodiments, the system includes a wireless communication subsystem configured to exchange data with a mobile application, remote server, kiosk, desktop program, or another external device. The wireless subsystem may include Bluetooth, Bluetooth Low Energy, Wi-Fi, near-field communication, ultra-wideband, or another communication protocol. Through such communication, a user may upload new motion data, adjust playback settings, rename stored sessions, select color palettes, choose event emphasis, initiate firmware updates, or compare multiple stored athletic motions. In some embodiments, the base may store multiple motion profiles, each associated with a different athlete, club, date, tournament, lesson, milestone, or commemorative event. A user may select among the stored profiles using a mobile app, a physical button, a gesture, a spoken command, or another input mechanism.

In certain embodiments, the system supports a comparison mode in which a first reconstructed motion and a second reconstructed motion are replayed together or in alternating fashion. The two motions may correspond to a before-and-after coaching comparison, a user swing and a professional reference swing, two different clubs, two different athletes, or two events from different dates. In one implementation, the sculpture includes a single path and the control subsystem alternates between two color-coded playback programs associated with different datasets. In another implementation, the sculpture includes two separate path bodies mounted to a common base, with each path illuminated separately or in synchronized relation. In some embodiments, haptic output or audio commentary is generated to indicate divergence between the compared motions at one or more event times or spatial regions.

In some embodiments, the system is configured to synchronize playback with external media. For example, the base may include a QR code, NFC tag, machine-readable marker, or displayed code that causes a viewer's mobile device to open an associated video, augmented-reality experience, coaching interface, event page, or authentication record. Upon activation, the mobile device may play the original or edited athletic video in synchrony with the sculpture's illumination sequence. In certain implementations, the sculpture transmits a synchronization signal or time code to the mobile device so that the visual replay on the device and the light/haptic replay in the sculpture remain temporally aligned. In other implementations, both the sculpture and the mobile device reference a common normalized timebase associated with the stored motion data.

In certain embodiments, the system includes a power subsystem. The power subsystem may include a rechargeable battery, replaceable battery, wired power input, magnetic charger, USB interface, wireless charging coil, or another electrical power arrangement. In some implementations, the system enters a low-power sleep mode after inactivity and wakes in response to touch, motion, or proximity sensing. In certain embodiments, the sculpture body itself contains only low-voltage light components, while power conversion and energy storage remain in the base. In other embodiments, the base and sculpture are separable and include electrical contacts or inductive coupling surfaces to supply power to light-emitting elements within the sculpture.

In some embodiments, the system includes thermal, fault, and safety management features. For example, the control subsystem may limit brightness or duty cycle if a temperature sensor indicates elevated temperature within the base or sculpture. A watchdog timer may reset the control system in the event of software failure. Sensor inputs may be filtered to avoid unintended repeated triggering from spurious motion or electrical noise. Low-battery states may be indicated by a dedicated light pattern, audio tone, or app notification. In certain embodiments, the system disables high-intensity output during charging or while the sculpture is detached from the base.

In certain implementations, the physical geometry of the sculpture is itself designed to support more effective playback. For example, the internal channel diameter, wall thickness, light-scattering texture, reflective coating, bend radius, and emitter spacing may be selected to improve apparent continuity of a moving light pulse through curved regions of the path. A semi-transparent diffusing core may be used to blur individual emitters into a continuous ribbon of light. Faceted internal surfaces may amplify sparkle or directional highlights. Time-indexed ridges or surface markers may cooperate with light pulses to create a visually legible sense of progression through distinct portions of the athletic motion. Thus, in some embodiments, the sculpture's geometry and the playback system are co-designed rather than independently selected.

In some embodiments, the system generates a playback-specific geometric segmentation during CAD modeling. During model generation, the path may be partitioned into segments associated with events, speed ranges, curvature ranges, or user-selected milestones. Each segment may then be assigned corresponding lighting zones, haptic triggers, or control identifiers. This segmentation may be embedded in the digital model and carried forward into manufacturing, assembly, and programming. In some embodiments, a digital twin representation of the sculpture is maintained, including both physical geometry data and control-mapping data, thereby enabling consistent manufacturing and later software updates for that specific object.

In one illustrative implementation, a golf swing is reconstructed as a time-ordered three-dimensional path of a club head. The path is converted into a hollow semi-transparent tube mounted on a wooden base. A flexible addressable LED strip is routed through the tube such that each LED corresponds to a successive arc-length interval along the path. The base houses a microcontroller, battery, Bluetooth module, capacitive touch sensor, linear resonant actuator, and speaker. The reconstructed path data is converted into a playback table containing timestamped LED-index positions, brightness values derived from local club-head speed, an event marker at transition, an impact marker, and an audio cue synchronized to impact. When a user touches the base, the system executes a playback program in which a pulse of light travels through the tube at the tempo of the original swing, the actuator produces a first subtle pulse at transition and a stronger pulse at impact, and the speaker emits a short strike sound. Through a companion application, the user may switch to slow-motion playback, change colors, or compare the stored swing with another captured swing from a later date.

In another illustrative implementation, the sculpture is metallic and opaque, but includes a narrow translucent edge strip extending along the motion path. Light emitted into the strip creates a traveling edge glow rather than illuminating the full body. The base includes an optical proximity sensor rather than a touch sensor, and automatically starts playback when a viewer approaches. A comparison mode causes two different swing datasets to play sequentially in two different colors, while haptic output indicates points of greatest path deviation between the two datasets. In this manner, the interactive sculpture serves both commemorative and coaching functions.

In certain embodiments, one or more aspects of the system are customizable. A user may choose among materials, finishes, base engravings, event emphasis levels, color themes, ambient idle effects, audio selections, sensitivity thresholds, or output intensities. The base may include engraved metadata such as athlete name, date, venue, club type, tournament, or performance metric, and the control subsystem may use corresponding metadata to determine a default playback theme. In some embodiments, a celebratory mode is automatically enabled for milestone events, such as a first hole-in-one, tournament win, personal-best swing speed, or notable competition shot.

The foregoing interactive embodiment advantageously extends the underlying motion-derived sculpture from a static artifact into a replayable, data-driven, and sensory-rich physical system. By associating time-indexed reconstructed motion data with one or more visual, tactile, and audible outputs, the system enables a viewer not only to see the geometry of the athletic motion, but also to experience its tempo, transitions, and defining moments in a synchronized and memorable manner.

In further embodiments, the systems and methods described herein are adapted to generate three-dimensional physical artifacts representing athletic motions other than a golf swing. While certain embodiments herein are described with reference to a golf club head trajectory, the underlying capture, reconstruction, modeling, and fabrication pipeline is not limited to golf and may be applied to any athletic movement for which a temporally varying path, posture-derived motion feature, object trajectory, or motion envelope can be measured, inferred, or reconstructed in three dimensions. In various implementations, the tracked motion may correspond to a piece of sporting equipment, a ball, a body extremity, a joint, a center of mass, a representative point derived from pose data, a composite motion path, or a combination thereof.

In some embodiments, the system first classifies the athletic activity represented in the captured data and then selects a sport-specific processing workflow. The sport-specific workflow may determine which object or body feature is tracked, which events are identified, which geometric constraints are applied during reconstruction, which motion attributes are emphasized during modeling, and which base or display features are used in the final artifact. In one implementation, a sport classifier determines whether an input sequence corresponds to golf, tennis, baseball, basketball, figure skating, hockey, lacrosse, soccer, volleyball, martial arts, dance, or another athletic activity. The classifier may use video appearance, body pose, tracked equipment shape, event timing, metadata, or user input. Once a sport or motion type is identified, the system may invoke a corresponding reconstruction model, event taxonomy, geometry-generation template, and manufacturing profile.

In certain embodiments, the system does not limit the artifact to a direct reproduction of a single point path. Instead, the system may derive one or more motion primitives from the underlying athletic action and use such primitives as the basis for the resulting three-dimensional object. By way of example, the system may represent a ball path, an implement path, an athlete's center-of-mass path, a swept volume, a posture transition envelope, a hand path, a foot path, a rotation axis trace, a bat plane, a racquet-face orientation ribbon, or a combination thereof. In some implementations, multiple motion primitives are combined into a unified sculpture. In others, they are spatially offset, nested, layered, interwoven, or mounted together on a common base so that different aspects of the athletic motion can be visually compared.

In some embodiments, the system defines an event-aware timeline for the particular sport and uses such event timing both for reconstruction and for geometry generation. For example, golf may use address, takeaway, top of backswing, transition, impact, and finish; tennis may use toss, racquet drop, acceleration, contact, pronation, and recovery; baseball batting may use load, stride, launch, contact, extension, and finish; baseball pitching may use windup, leg lift, hand break, stride foot contact, arm-cocking, acceleration, release, and deceleration; basketball may use gather, rise, release, apex, rim entry, and landing; and figure skating may use entry edge, takeoff, airborne rotation, landing, exit edge, and choreographic transition. In certain embodiments, the local geometry of the final artifact is modulated according to these event phases, such that the physical object communicates not only where the motion occurred in space but also how the motion evolved through time.

### Tennis Embodiments

In certain embodiments, the invention is adapted to reconstruct and physically represent a tennis motion, such as a serve, forehand, backhand, volley, overhead, slice, or return. In one implementation, the system tracks the motion of the racquet head over time using one or more videos, depth-estimation routines, body-pose-assisted inference, or sensor-derived data. In some embodiments, the tracked motion is supplemented by one or more additional features, such as the path of the player's hitting hand, the trajectory of the tossed ball during a serve, the trajectory of the struck tennis ball after contact, the orientation of the racquet face, or the rotational posture of the player's torso and shoulders.

In one embodiment directed to a tennis serve, the system reconstructs: (i) a tossed-ball path; (ii) a racquet-head path; and (iii) a post-contact ball trajectory. These paths may be modeled individually or combined into a single integrated structure. For example, the toss path may be represented as a slender ascending strand, the racquet path as a broader twisted ribbon, and the outgoing ball trajectory as a narrow arc extending away from the contact region. The three paths may intersect or nearly intersect at a contact node corresponding to the serve impact point. In some implementations, the contact node is physically emphasized by a faceted junction, localized thickening, gemstone setting, light-emitting element, engraved marker, or texture change.

In certain embodiments, the system derives and encodes tennis-specific parameters into the geometry. These parameters may include racquet-head speed, spin generation, swing path steepness, contact height, pronation timing, follow-through direction, or topspin versus slice character. For example, a topspin-heavy serve may be represented by a helical or spiraling local twist near the contact and follow-through region, whereas a flatter serve may be represented by a cleaner, narrower, more direct extension. In some embodiments, forehands and backhands are distinguished by directional asymmetry, handedness encoding, or side-specific base orientation. The resulting physical artifact may serve as a commemorative keepsake, a coaching aid, or a visual record of a signature shot.

### Baseball Batting Embodiments

In certain embodiments, the invention is adapted to the motion of a baseball bat during a swing. In one implementation, the system tracks the barrel end, sweet spot region, bat centerline, knob, or another selected bat-associated point throughout the swing. In some embodiments, multiple points on the bat are tracked, allowing the system to reconstruct not merely a single centerline path but also the changing bat orientation and bat plane over time. From such information, the system may generate a three-dimensional physical artifact representing the path of the bat barrel, the swept hitting zone, the temporal opening and closing of the bat plane, or the region of likely contact through the hitting zone.

In one embodiment, the artifact is not simply a line following the barrel path, but a thickened contact-volume sculpture representing the space through which the hitting region of the bat passes during the critical contact interval. This contact-volume sculpture may be generated by sweeping a bat-contact profile through a time-bounded portion of the reconstructed motion, thereby creating a manufacturable body that visually communicates attack angle, bat lag, rotational acceleration, and extension through contact. In some implementations, pre-contact and post-contact portions are represented differently from the contact interval. For example, the load phase may be shown as a thinner approach segment, the hitting zone as a widened and more substantial sculptural body, and the follow-through as a tapering extension. This embodiment is particularly useful in player development, where the artifact may visually distinguish an “inside-out” path from a more rotational or pull-dominant path.

In certain embodiments, ball-flight data is also incorporated. If a ball is successfully struck and its initial exit trajectory is captured or inferred, the system may generate a dual-path artifact in which the bat path and ball path are joined at a contact junction. The ball path may be encoded with a different cross-sectional shape, a different material, a contrasting finish, or a suspended secondary arc. In some implementations, the base includes game metadata, pitch type, exit velocity, launch angle, or date and venue of the hit.

### Baseball Pitching Embodiments

In certain embodiments, the invention is adapted to represent a pitched baseball and/or the motion of the pitcher's throwing arm. In one implementation, the tracked motion is the three-dimensional trajectory of the baseball from hand release through an initial portion of flight. In another implementation, the system reconstructs both the hand path and the ball path, thereby producing a dual-structure artifact showing the relationship between arm slot and pitch movement. In some embodiments, different pitch types are encoded differently in the artifact. For example, a four-seam fastball may be represented by a relatively direct and rising-appearing path, a slider by an increasingly laterally deviating path, a curveball by a more downward-bending path, and a changeup by a smoother, deceptively similar path with altered temporal encoding.

In certain embodiments, spin-derived parameters are integrated into the geometry even where the sculpture does not physically rotate. For example, the local cross-section may rotate progressively along the path to encode spin axis; ribbing density may encode spin rate; or surface texture may change near the release region to indicate grip-related characteristics. In some implementations, the release point is emphasized by a node, collar, flange, or jewel-setting feature, while the flight path is represented as a suspended arc emerging from that release point. In a coaching embodiment, multiple pitch trajectories may be mounted together on a common base to compare movement profiles, release consistency, or pitch tunneling.

### Basketball Embodiments

In certain embodiments, the invention is adapted to represent a basketball shot, pass, dribble sequence, or free throw. In one implementation, the system reconstructs the trajectory of the basketball from the player's release point toward the rim. In some embodiments, the hand trajectory, wrist snap motion, elbow path, or body centerline is also tracked and integrated. For a jump shot, the final artifact may include a first path corresponding to the ball trajectory and a second path corresponding to the player's shooting hand or release motion. These paths may be joined or arranged adjacently near the release region to emphasize the transition from player-controlled motion to free-flight ball motion.

In some embodiments, the path of the ball is represented as a smooth arching body whose curvature and thickness encode launch angle, ball speed, arc height, or spin characteristics. A made shot may terminate at or near a ring-like rim reference integrated into the sculpture or base, while a game-winning or commemorative shot may include additional metadata, such as score, game clock, venue, or opponent. In some implementations, the release node is embellished or locally thickened to indicate a “green release,” high-confidence shot mechanics, or a particularly notable moment. In a training embodiment, multiple shot trajectories from different court positions may be arranged around a common base, thereby creating a spatial “shot signature” of a player's form and range.

### Figure Skating Embodiments

In certain embodiments, the invention is adapted to represent skating motion on ice or another surface. Unlike embodiments focused on a single tracked object such as a club head or ball, the figure skating embodiment may use a body-derived motion primitive, such as the skater's center of mass, hand position, skate-blade tip, shoulder line, or a selected choreography point. In one implementation, the system reconstructs the path of a skate blade over the ice together with one or more elevated body-part paths during a jump, spin, spiral, or step sequence. The resulting artifact may therefore represent not merely a floor trace, but a three-dimensional choreography of the routine.

In some embodiments, a jump is represented by an entry path, an airborne helical segment encoding rotation, and a landing path. The airborne helical segment may have a number of turns, local twists, or faceted rotations corresponding to the number of rotations performed during the jump or an approximation thereof. In a spin embodiment, the system may represent the spin as a tightly wound vertical or conical coil, optionally transitioning into a broader exit curve. In a spiral or glide embodiment, the system may create an elongated ribbon whose width varies with edge quality, body extension, or music intensity as derived from synchronized audio or event metadata.

In certain embodiments, routine-level data is used to generate an integrated performance sculpture combining multiple sequential elements. Distinct jumps, spins, and transitions may be connected into a continuous body or represented as linked modules mounted to a shared base. In some embodiments, the base includes the music title, score, venue, event date, or competition level. In others, lighting or engraving indicates where major technical elements occur within the overall routine.

### Additional Sport-Specific and Generalized Embodiments

In further embodiments, the system is adapted to hockey slapshots, lacrosse shots, volleyball serves and spikes, soccer kicks, bowling releases, martial arts strikes, gymnastics routines, dance movements, swimming strokes, track-and-field throwing motions, cycling pedal paths, rowing strokes, and other repetitive or noteworthy athletic actions. In some cases, the tracked path corresponds to the motion of equipment; in others, it corresponds to a limb extremity, center of mass, or force-application path. The system may also reconstruct compound motions from multiple participants, such as a pitcher-to-batter interaction, a tennis rally moment, a skater pair movement, or a basketball pass-and-shot sequence, and represent such motions as intersecting, synchronized, or spatially coordinated sculptural elements.

In certain embodiments, the system is configured to choose a default geometry family based on motion type. A projectile trajectory may be represented as a tubular arc; a swinging implement path may be represented as a twisted ribbon or faceted loft; a body centerline motion may be represented as a flowing shell or wave form; and a contact-volume path may be represented as a broadened swept envelope. Thus, the physical artifact need not be limited to a single aesthetic or structural schema across all sports, but may instead reflect the kinematic character of the underlying motion. In some implementations, the final artifact includes a legend, encoded markers, material transitions, or modular pieces indicating whether the represented structure corresponds to equipment motion, body motion, projectile motion, or an interaction between them.

In further embodiments, the invention is adapted to generate wearable objects and miniature personal artifacts derived from reconstructed athletic motion. In contrast to embodiments in which the reconstructed path is fabricated as a free-standing sculpture mounted on a display base, the present embodiments convert motion-derived geometry into forms suitable for wearing on the body, carrying as a keepsake, attaching to accessories, or incorporating into ornamental objects. Such embodiments are not limited to simple downscaling of a larger sculpture. Rather, they may include one or more transformation stages that modify the reconstructed geometry to satisfy aesthetic, ergonomic, structural, comfort, fastening, manufacturability, and precious-material requirements specific to jewelry and wearable design.

In certain embodiments, the system receives as input a reconstructed motion path, a derived centerline, a swept surface, a contact node, a motion envelope, or another motion-based geometry and applies a jewelry-conversion process. The jewelry-conversion process may include one or more of scaling, smoothing, local thickening, self-intersection avoidance, balance adjustment, orientation optimization, attachment-feature generation, loop generation, bail formation, post formation, clasp accommodation, skin-clearance adjustment, comfort-surface creation, stone-seat insertion, personalization engraving, and manufacturability validation. In some embodiments, the system automatically selects among multiple jewelry archetypes based on the shape, curvature, complexity, or symbolic significance of the underlying motion.

In some embodiments, the jewelry-conversion process first identifies a principal display region of the reconstructed motion geometry. The principal display region may correspond to a high-curvature region, a contact point, a transition segment, an impact node, a distinctive loop, or another visually significant portion of the original athletic motion. The system may then orient the geometry so that the principal display region faces outward when worn. In some implementations, the system computes a center of visual mass and a center of physical mass and adjusts the orientation or mounting features to reduce twisting, flipping, or uncomfortable hanging when the piece is worn. This is particularly useful for pendants and earrings, where orientation stability may affect both appearance and comfort.

### Pendant Embodiments

In one embodiment, the reconstructed motion geometry is converted into a pendant. The pendant may include a suspended motion-derived body and an integrated or attached bail, loop, jump-ring interface, hinge, or hidden chain passage. In some implementations, the bail is positioned at a point along the motion geometry selected to maintain a desired display orientation when the pendant hangs from a chain. The selected point may correspond to a local thickness maximum, a structurally reinforced node, a low-visibility rear-facing segment, or a specially generated support extension. In certain embodiments, the bail is not merely appended, but is blended into the reconstructed motion geometry so that it appears as a natural continuation or closure of the path.

In some embodiments, the pendant preserves a recognizable portion of the motion, such as the impact region of a golf swing, the apex of a basketball shot, the contact node of a tennis serve, or the release arc of a baseball pitch. In other embodiments, the full motion path is retained but compacted by controlled scaling, folding, planar projection, or spiral wrapping so that the resulting piece remains wearable. In certain implementations, the pendant may include an accent feature positioned at a key motion event, such as a gemstone located at a contact point, a contrasting inlay at impact, or a text engraving indicating athlete, date, venue, or performance metadata.

### Earring Embodiments

In certain embodiments, the motion-derived geometry is adapted to form one or more earrings. An earring may include a post-backed stud, hook-supported drop, hoop-integrated path element, cuff-attached piece, or other wearable ear format. In one implementation, the system generates a post connection at a structurally suitable location on the motion-derived body so that the earring hangs with a desired orientation and without excessive torsional rotation. In some embodiments, the system generates paired earrings from a single motion dataset by dividing the motion into complementary portions, such as backswing and follow-through, pre-contact and post-contact, ascent and descent, or left-and right-oriented mirrored variants. In other embodiments, the pair is asymmetrical, with one earring corresponding to a first motion feature and the other corresponding to a second motion feature from the same athletic event.

In some implementations, the system automatically checks earring-specific constraints, including allowable weight, drop length, edge softness, snag resistance, and center-of-gravity placement relative to the ear attachment point. To satisfy these constraints, certain portions of the motion geometry may be locally thickened, hollowed, perforated, chamfered, rounded, or removed. A pronounced twist or undercut may be simplified for comfort and manufacturability while preserving the expressive character of the original motion. In some embodiments, a pair of earrings is generated so that the two pieces together tell a temporal story of the underlying motion, for example one earring encoding preparation and the other encoding completion.

### Ring Embodiments

In certain embodiments, the reconstructed athletic motion is adapted into a ring. In one implementation, a selected segment of the reconstructed path is transformed into a continuous loop defining a finger-receiving band. The selected segment may correspond to a naturally curved portion of the motion, such as a follow-through arc, racquet loop, airborne jump segment, or ball-flight curvature. In some embodiments, the selected segment is wrapped or mathematically re-parameterized around a ring circumference while preserving one or more local geometric signatures of the original motion, such as curvature maxima, directional flow, or event-associated nodes. In other embodiments, the ring band provides a stable base form, and the motion-derived geometry is mounted upon, intertwined with, or projected from the band as a raised sculptural feature.

In some implementations, the ring includes a focal element at a significant motion event. For example, a gemstone, faceted metal form, bead, or elevated node may be positioned at an impact location, release point, apex, or transition. In certain embodiments, the outer surface of the ring includes time-indexed ridges, directional engravings, spin-encoding grooves, or localized texturing corresponding to motion-derived attributes. In other embodiments, the interior of the ring band includes hidden engravings derived from the athletic event, such as date, coordinates, opponent, score, shot type, or athlete initials. Ring embodiments may include signet-style tops, bypass forms, tension-like settings, open-ended forms, or wraparound geometries generated from or inspired by the reconstructed motion.

### Bracelet, Cuff, Charm, and Accessory Embodiments

In further embodiments, the motion-derived geometry is incorporated into bracelets, cuffs, charms, watch attachments, keychains, tie bars, cuff links, money clips, belt buckles, bag charms, medallions, lapel pins, hat pins, brooches, and other personal accessories. In a bracelet embodiment, the motion path may be distributed around a wristband as a continuous flowing relief or as a sequence of linked charm elements corresponding to successive motion phases. In a cuff embodiment, the open ends of the cuff may terminate at two significant event points in the motion, such as address and impact, or toss and contact. In a cuff-link embodiment, a pair of motion-derived miniatures may represent coordinated but distinct motion segments. In certain embodiments, a keychain or bag charm preserves more of the full three-dimensional complexity of the path because body-contact comfort constraints are reduced relative to jewelry worn directly on the skin.

### Geometry Transformation for Wearability

In some embodiments, the system applies one or more geometry transformations specifically to make a motion-derived object suitable for wear. These transformations may include reducing extreme aspect ratio, eliminating sharp protrusions, increasing minimum feature size, merging closely spaced segments, smoothing high-frequency curvature, introducing support bridges between adjacent path regions, converting isolated floating features into connected forms, or hollowing thicker regions to reduce weight. In certain implementations, the system checks for self-intersection, trapped voids, fragile cantilevers, and unsupported overhangs likely to be problematic in casting, printing, polishing, or daily wear. A jewelry-specific manufacturability module may repair such conditions automatically while preserving as much of the original motion signature as practicable.

In some embodiments, the system computes a structural-risk map over the motion-derived geometry. The structural-risk map may identify portions likely to be vulnerable to bending, snagging, fatigue, cracking, or deformation during wear. Based on the map, the system may selectively thicken certain sections, introduce fillets or gussets, shorten unsupported spans, modify local cross-sections, or change connection topology. In this manner, the resulting jewelry object is not merely an ornamental copy of the larger sculpture, but a physically robust article engineered for repeated wearing.

### Material-Specific Adaptation

In certain embodiments, the system adapts the motion-derived geometry according to the intended material. Precious metals such as gold, silver, platinum, palladium, and alloys thereof may permit certain minimum wall thicknesses, polishing behaviors, and casting tolerances, while titanium, stainless steel, aluminum, resin, ceramic, carbon composite, or plated materials may require different design rules. In one implementation, the system applies a material profile containing permissible thickness ranges, shrinkage compensation values, polishing allowances, prong or loop tolerances, and recommended support geometry. The jewelry-conversion process may thus generate different versions of the same motion-derived object for different materials or price tiers.

In some embodiments, the final piece includes multiple materials. For example, a motion-derived body may be cast in one metal and mounted to an accent ring, bezel, or support structure of another metal. A contact event may be indicated by a gemstone, enamel fill, contrasting metal insert, ceramic inlay, fiber-optic element, or luminescent resin. In some embodiments, a transparent stone or resin lens is placed over a key motion node, thereby magnifying or highlighting the point corresponding to impact, release, apex, or another moment of significance.

### Manufacturing Workflows for Jewelry Embodiments

In certain embodiments, the wearable object is fabricated using a jewelry-specific production workflow. In one implementation, a digital model derived from the reconstructed motion is converted into a castable model and then produced by lost-wax casting. The castable model may be printed in wax, resin, or another sacrificial material and encased in an investment material to form a mold. Molten metal is then introduced into the mold to replace the sacrificial model, after which the cast piece is cleaned, cut, polished, set, and finished. In some embodiments, support sprues, feed paths, venting features, and shrinkage-compensation allowances are generated automatically based on the motion-derived geometry and desired metal.

In other embodiments, the object is formed by direct metal printing, micro-casting, CNC milling, electroforming, stamping, forging, laser sintering, binder jetting followed by infiltration, or combinations thereof. In some embodiments, a rough printed or cast form is subsequently hand-finished to preserve intentional facets or smooth selected regions. In certain implementations, portions of the motion geometry are deliberately left with a more organic or data-derived surface texture so as to preserve the visual identity of the underlying athletic event.

### Personalization, Authentication, and Linked Data

In some embodiments, the wearable object includes a hidden or visible identifier linking the piece to the original athletic motion from which it was derived. The identifier may include a serial number, engraved code, micro-engraving, QR code, NFC element, RFID component, blockchain-linked certificate reference, or another authentication feature. Through the identifier, the owner may access a digital record containing the source video, event metadata, athlete information, model preview, certification of origin, or a replay of the original motion. This can be especially useful for commemorative pieces associated with tournaments, gifts, achievements, team events, or limited-edition collections.

In certain embodiments, a user or purchaser selects among different abstraction levels. A first abstraction level may preserve nearly the full original motion geometry. A second abstraction level may simplify the motion into a cleaner ornamental line retaining only major directional changes. A third abstraction level may isolate a single expressive event region, such as impact or apex, and use that region as the basis for a more subtle luxury piece. Thus, the same captured athletic motion may yield a spectrum of wearable forms ranging from highly literal to highly stylized.

### Motion-Derived Families and Matched Sets

In some embodiments, the system generates a family of related wearable objects from a single athletic event. For example, a pendant may use the overall motion path, earrings may divide the motion into two complementary phases, and a ring may emphasize the event node. In another embodiment, matched sets are generated from different motions associated with the same athlete, season, match, or milestone. A collection may include a championship serve pendant, a tournament-winning forehand ring, and commemorative earrings based on a decisive point. Such families may share common cross-sectional language, surface textures, event-node treatment, or engraving schemes.

### Exemplary Jewelry Implementation

In one illustrative implementation, a golfer's swing is reconstructed as a three-dimensional club-head path. A jewelry-conversion module identifies the impact-to-follow-through region as a principal display region because it contains a distinctive curvature and symbolic significance. The module scales the region to pendant size, smooths micro-irregularities, thickens a narrow transition, and blends an integrated hidden bail into a rear segment of the path so that the pendant hangs with the impact region facing forward. A small gemstone seat is added at the impact node. The pendant is exported as a castable model, printed in castable resin, cast in gold, polished on selected outer surfaces, and engraved on the reverse with the golfer's initials and event date. An authentication number links the piece to a digital certificate and a replay of the original motion. In this manner, the resulting pendant is not merely a miniature sculpture, but a wearable physical embodiment of a particular athletic moment.

In another illustrative implementation, a tennis serve is reconstructed from video and converted into a matched pair of earrings. One earring corresponds to the toss-and-racquet-drop portion of the serve, while the other corresponds to the acceleration-and-follow-through portion. Each earring is optimized for weight and balance, provided with rounded edges, and fitted with a post at a location selected to orient the piece correctly when worn. A pair of small stones is set at the contact-related regions. The result is a coordinated but asymmetrical pair of wearable objects, each derived from a different temporal segment of the same athletic action.

FIG. 1A shows a perspective view of a swing sculpture 100 that visually represents the motion path of a golf club head during a golf swing. The sculpture 100 is formed as a continuous, solid body that follows the reconstructed three-dimensional trajectory of the club head. In the example shown, the sculpture has a smooth, curved form that transitions through the backswing, downswing, and follow-through phases of the swing. The cross-section of the sculpture may be defined as a triangular or square prism, and its dimensions may vary along the path to reflect changes in swing dynamics such as speed or directionality.

FIG. 1B provides a side elevation view of the sculpture 100. This view highlights the arc-like nature of the swing path, with the backswing portion curving upward and rearward, the downswing descending with increased intensity, and the follow-through rising and extending forward. In the embodiment shown, the sculpture's thickness increases and decreases along the path to visually encode swing characteristics, such as acceleration or moment of impact. The base end of the sculpture includes a protruding screw or anchoring feature 102 that is used to secure the sculpture to a display base.

FIG. 1C is a top-down view of the sculpture 100, showing the lateral displacement and curvature of the swing path in the horizontal plane. This view further illustrates the continuous nature of the path and helps convey the spatial relationship between the backswing, downswing, and follow-through portions. The sculpture may optionally include internal lighting or surface finishes that enhance visual contrast and aesthetic appeal.

In some embodiments, the sculpture 100 may be fabricated using metal additive manufacturing and mounted on a display base (not shown) that includes a threaded socket configured to receive the anchoring feature 102. The base may further include identifying indicia, embedded electronics, or augmented reality tags as described in the detailed embodiments above.

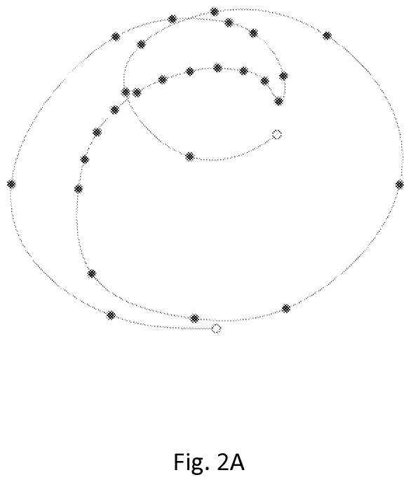

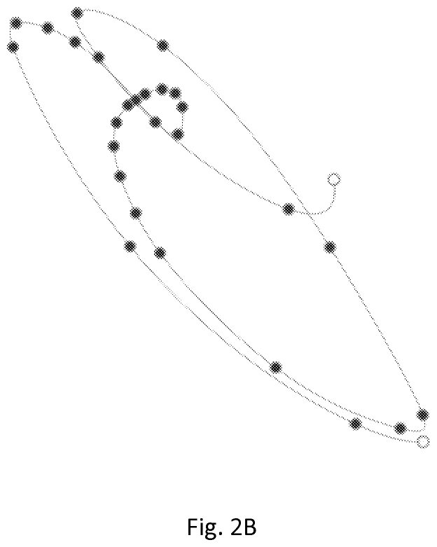

FIG. 2A illustrates an example point cloud 200 generated from a three-dimensional reconstruction of a golf club head's motion during a swing. The point cloud consists of a series of discrete spatial coordinates representing the position of the club head at successive time intervals throughout the swing. These coordinates may be obtained via triangulation from synchronized video footage, depth estimation, or projection-based methods. In the illustrated embodiment, the point cloud is sparsely sampled to approximately 75 points, capturing the general shape and tempo of the swing while preserving clarity for downstream modeling.

FIG. 2B shows the swing path 210 fit to the point cloud 200. The swing path 210 represents a continuous curve derived from the underlying point data using interpolation or spline-fitting techniques. This path may be used as the centerline for generating a solid three-dimensional model, as described in connection with FIGS. 1A through 1C. The fitting process ensures that the resulting sculpture reflects the real motion captured in the source video while smoothing out noise and inconsistencies in the raw data.

The fitted path 210 may additionally be processed to apply dynamic thickness, twisting, or other geometric variations along its length to encode swing metrics such as velocity, acceleration, or transition points. In some embodiments, the swing path is exported from this stage in a structured data format, such as CSV or JSON, for import into a CAD system where the final model is constructed.

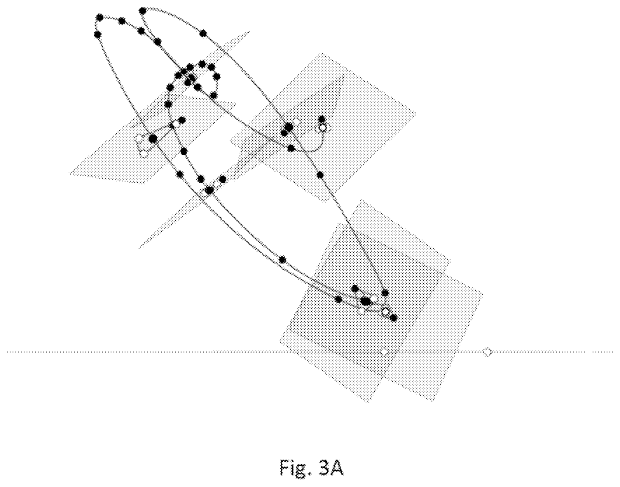

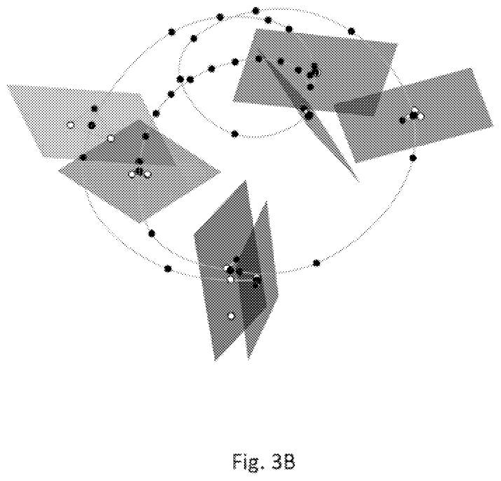

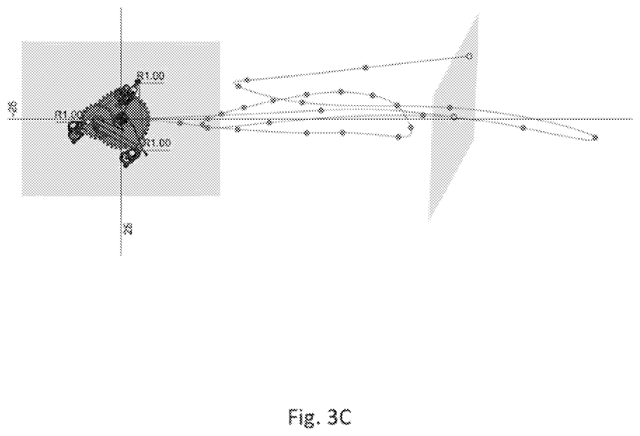

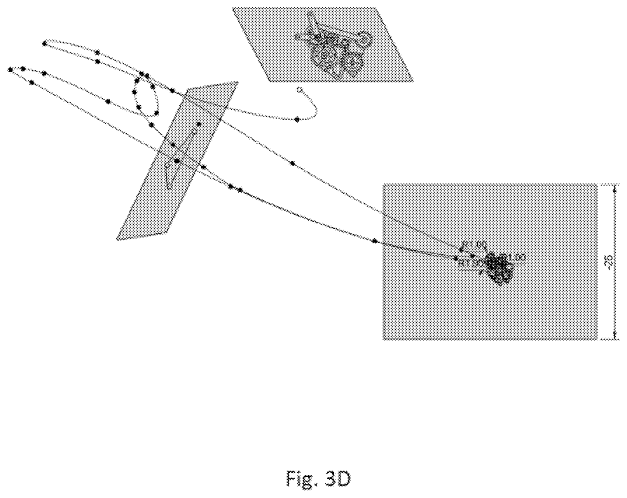

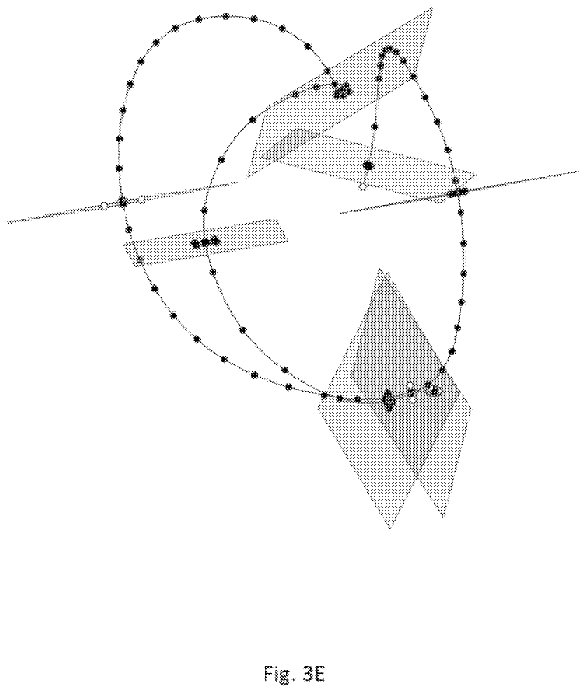

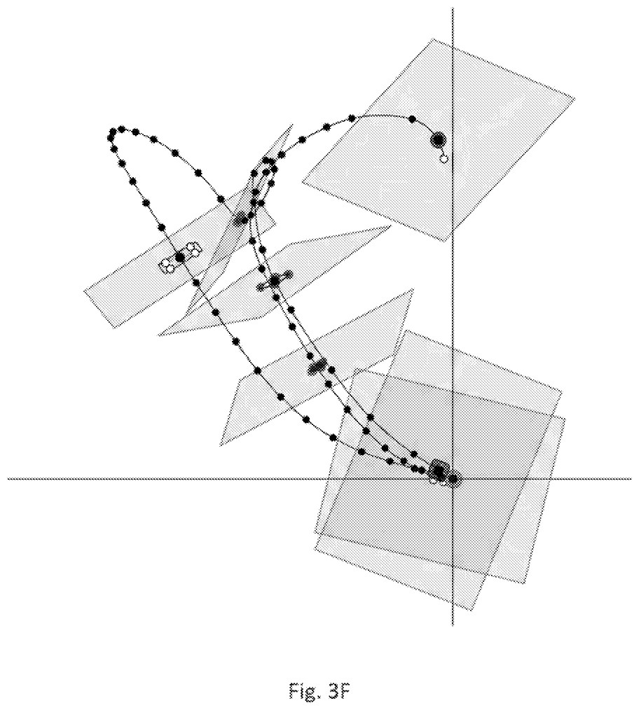

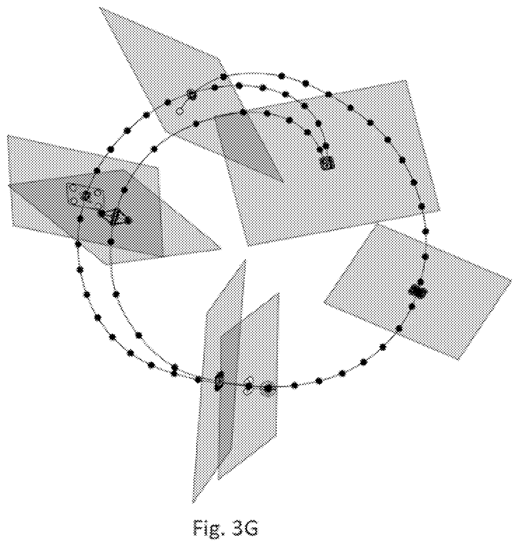

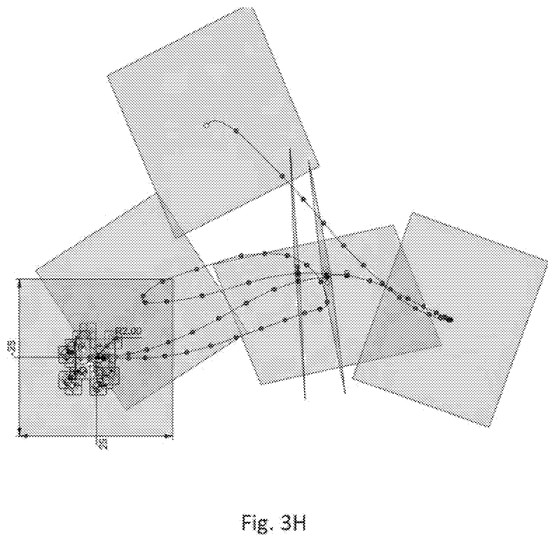

FIG. 3A shows a two-dimensional sketch 300 representing the swing path of the golf club head as reconstructed from motion capture data. This sketch is created in a computer-aided design (CAD) environment, such as Autodesk® Fusion 360®, and serves as the foundation for generating the three-dimensional sculpture.

FIG. 3B illustrates the same 2D swing path 300, now overlaid with a series of construction planes 310. These planes are orthogonal to the path and positioned at intervals corresponding to specific points along the swing trajectory. Each construction plane defines a cross-sectional location where a profile of the sculpture will be drawn.

FIG. 3C depicts a set of cross-sectional profiles 320 drawn on the construction planes. These profiles may be triangular, square, circular, or ribbon-like in shape and may vary in size along the swing path to represent changes in swing characteristics such as speed or energy transfer. The profiles are oriented to remain normal to the swing path at each construction plane.

FIG. 3D illustrates the selection of the profiles 320 and the initiation of the lofting operation 330. The Fusion 360 loft command is used to generate a smooth three-dimensional surface or solid body that transitions through each profile along the guiding path defined by the 2D sketch.

FIG. 3E shows the intermediate result of the loft operation, producing a continuous three-dimensional body 340 that closely follows the original swing path. The surface is smooth and captures the curvature and variation in the cross-sectional geometry defined by the input profiles.

FIG. 3F illustrates the completed solid body 350 after finalizing the loft operation. This body represents the finalized geometry of the swing sculpture and is ready for export in a 3D-printable format (e.g., STL or STEP).

FIG. 3G depicts a zoomed-in or sectioned view of the 3D body 350, highlighting the transition between adjacent profiles. The fluid blending of shape and size across the construction planes is a key feature enabled by the lofting process.

FIG. 3H shows the complete sculpture 360 with optional design refinements, such as a mounting interface or smoothing operations applied to the mesh. This model can then be exported for additive manufacturing, CNC milling, or other fabrication techniques.

In combination, FIG. 3A-3H illustrate the end-to-end CAD modeling process used to transform a reconstructed swing path into a manufacturable, three-dimensional sculpture. This method enables efficient creation of customized models directly from swing data and supports variable geometries tailored to individual swings.

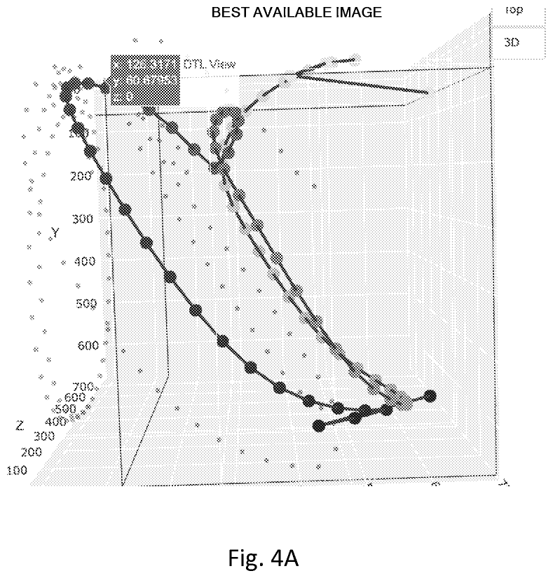

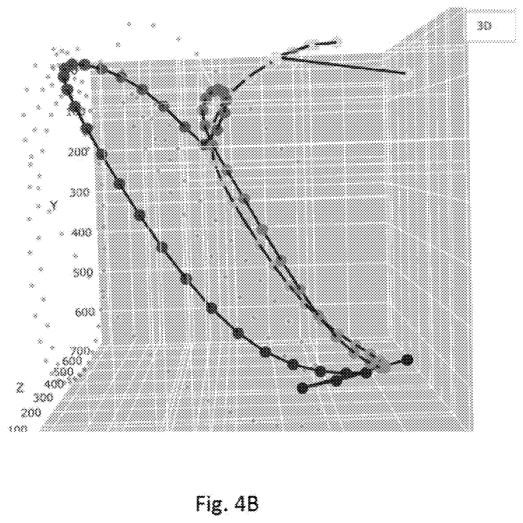

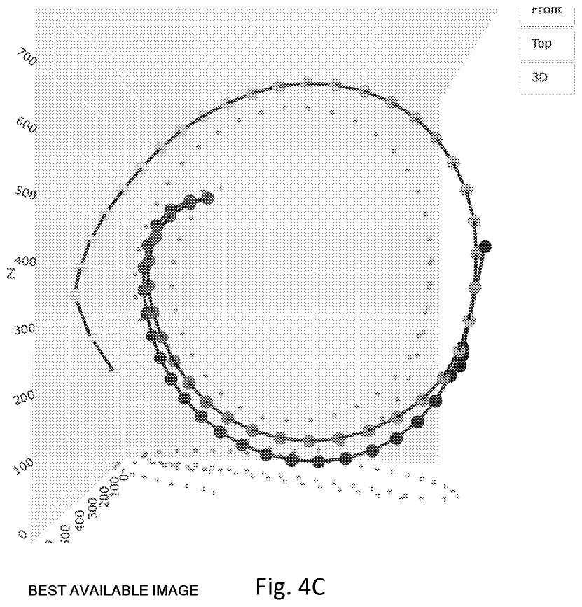

FIG. 4A shows a screenshot of a visualizer 400 implemented within the swing modeling codebase. The visualizer provides a three-dimensional rendering of the reconstructed swing path based on processed video data. This visualization environment allows the user to inspect the trajectory of the golf club head before proceeding with downstream modeling or export. In the illustrated view, the swing path is depicted as a sequence of connected line segments or smooth curves through a defined coordinate space.

FIG. 4B presents a rotated view of the same visualizer 400, offering a different perspective of the swing path. This multi-angle capability enables the user to verify the accuracy of the reconstruction and confirm that the motion has been captured correctly in three dimensions. In some implementations, the visualizer may allow user interaction, such as rotating, zooming, and panning the view, or even overlaying reference geometry or camera axes for context.

FIG. 4C depicts the swing path 410 annotated with time-indexed points, illustrating the uniform sampling of spatial data over the duration of the swing. This view enables quality control of both spatial distribution and swing tempo. Once verified, the three-dimensional coordinates—typically consisting of approximately 75 (x, y, z) points—can be exported as a comma-separated values (. csv) file. This file is then used as input for the CAD modeling workflow described in connection with FIGS. 3A-3H.

The visualizer thus acts as an important intermediate step in the pipeline, providing real-time feedback on the fidelity of the swing reconstruction and allowing for any necessary adjustments prior to model generation.

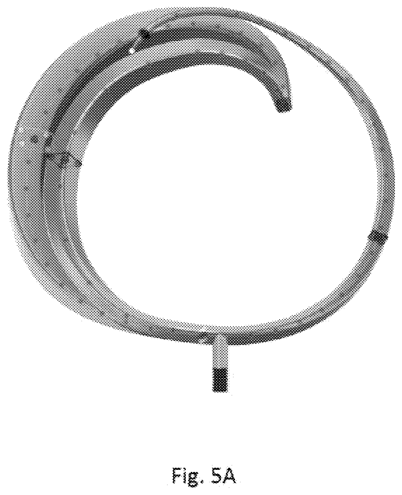

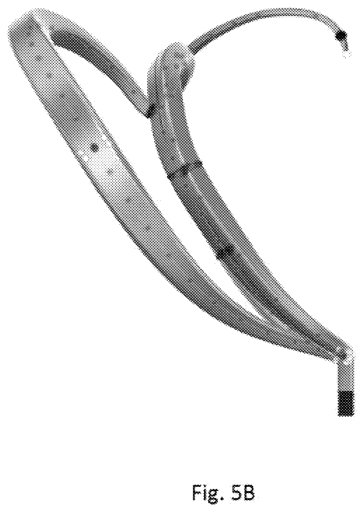

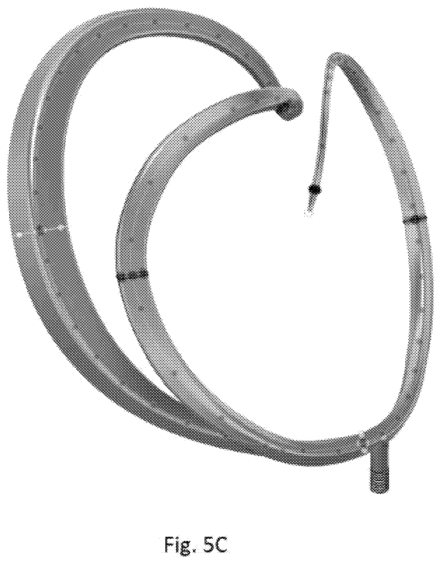

FIG. 5A illustrates a view within the Fusion 360® modeling environment showing a three-dimensional sculpture model 500 of a golf swing. In this example, the sculpture is rendered in Fusion 360's default gray appearance, without the addition of aesthetic surface textures or base features. Visible in the figure are the original sketch points 510 that define the trajectory of the club head through space. These sketch points were derived from reconstructed (x, y, z) coordinate data and serve as the foundation for modeling the swing path.

FIG. 5B shows a slightly rotated view of the same model, further illustrating how the sketch points 510 are connected to form a spline or continuous path along which the three-dimensional body 520 is constructed. This view highlights the clear relationship between the data-driven swing trajectory and the geometric features of the resulting solid model.

FIG. 5C provides a closer view of the lofted body 520 in relation to the guiding path defined by the sketch. Construction profiles are positioned along the path, and a loft operation is performed through these profiles to generate the final body. Unlike previous figures that show rendered surfaces with metal textures and mounting features, this version of the model demonstrates the core geometry in its raw, procedural form, allowing for clear inspection and refinement during development.

These figures emphasize the modularity and clarity of the modeling process, showing how the reconstructed swing path is directly and intuitively transformed into a manufacturable 3D model using standard CAD tools. This approach allows for rapid iteration and precise control over geometry at each stage of the design pipeline.

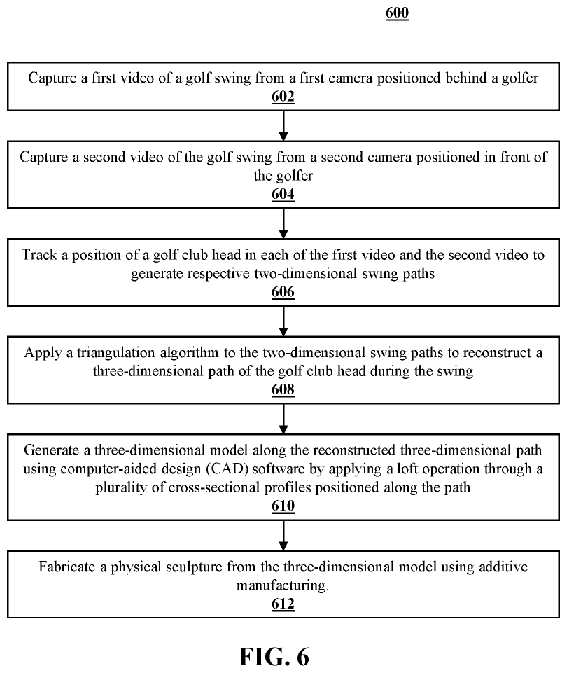

FIG. 6 illustrates a process flow 600 for generating a physical three-dimensional sculpture of a golf swing from dual-camera video data, in accordance with one or more embodiments of the present invention.

At step 602, a first video of a golfer executing a swing is captured from a camera positioned behind the golfer, commonly referred to as the “down-the-line” view. This camera is placed approximately 8 to 10 feet behind the golfer and elevated to about 5 feet to ensure full visibility of the golf club throughout the swing. The angle is chosen to preserve both the lateral and vertical arcs of the club head's motion.

At step 604, a second video is captured simultaneously from a front-facing camera positioned in front of the golfer. This viewpoint, also elevated at approximately 5 feet, provides critical depth information and captures motion that is not visible from the down-the-line angle alone. The dual perspectives allow for a more complete reconstruction of the club head's spatial motion.

At step 606, the position of the golf club head is tracked in each video frame of the respective recordings. This may be done manually using frame-by-frame annotation tools, semi-automatically using object detection algorithms, or fully automatically using computer vision models trained to detect and follow the club head. The output of this step is two distinct two-dimensional (2D) trajectories—one from each video—that represent the projected path of the club head over time from each viewpoint.

At step 608, a triangulation algorithm is applied to the paired 2D swing paths to reconstruct a three-dimensional (3D) trajectory of the golf club head. The algorithm computes the spatial coordinates of the club head at successive time intervals using geometric principles such as epipolar geometry, camera calibration matrices, and synchronized timestamps. The result is a temporally ordered set of three-dimensional coordinate points—typically around 75—that define the path of the club head throughout the swing.

At step 610, the 3D coordinate data is imported into a computer-aided design (CAD) environment, such as Autodesk® Fusion 360®. Within this environment, a smooth spline curve is generated to fit through the sampled points. Construction planes are positioned at regular intervals along the spline, and cross-sectional profiles—such as triangular or square shapes—are drawn on these planes. A lofting operation is then performed, whereby the CAD software connects the profiles to form a continuous solid body that follows the trajectory of the swing. In one implementation, the size or shape of each profile is modulated based on inferred swing characteristics, such as acceleration or tempo, creating a dynamic and expressive form that captures both the geometry and energy of the swing.

At step 612, the completed 3D model is exported as a mesh file, such as STL or STEP, and sent to an additive manufacturing system for fabrication. The sculpture is typically printed in metal using a powder bed fusion process, which offers high resolution and strength. Upon completion, the sculpture may be mounted on a wooden base using an integrated threaded screw, and optionally finished with polishing, engraving, or patina to create a personalized artifact. The final piece is a physical, artistic, and data-driven representation of the golfer's unique swing path.

This flow provides a closed-loop pipeline—from motion capture to sculptural output—that combines biomechanics, computational geometry, and digital fabrication to preserve and celebrate athletic motion in tangible form.

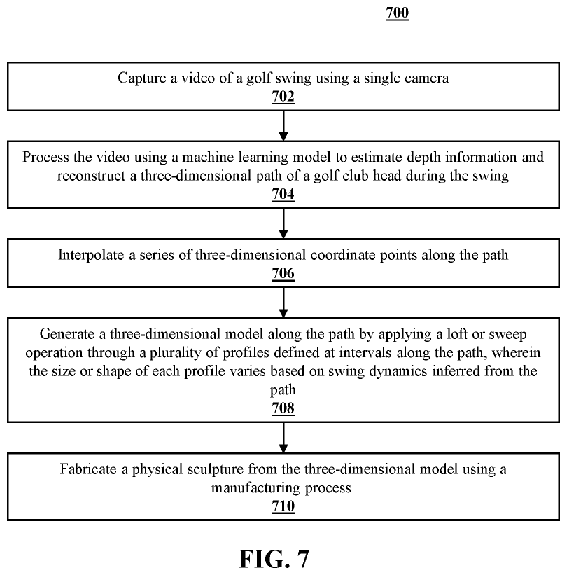

FIG. 7 illustrates a process flow 700 for generating a three-dimensional sculpture of a golf swing using a single-camera input and machine learning-based depth estimation, in accordance with one or more embodiments of the present invention.

At step 702, a video of a golfer performing a swing is captured using a single camera. This setup dramatically simplifies the hardware requirements, enabling users to record using a smartphone, webcam, or consumer-grade camera. The camera is typically positioned in a “down-the-line” orientation, about 8 to 10 feet behind the golfer and approximately 5 feet off the ground, to ensure a clear and consistent view of the club head throughout the motion. This approach is especially useful for at-home users or coaches working in minimal setups.

At step 704, the captured video is processed using a machine learning model designed to estimate depth and infer the three-dimensional position of the club head over time. The model may be implemented as a neural network trained on labeled motion datasets and configured to extract depth cues from frame-to-frame changes, object scale, parallax effects, and learned motion dynamics. A temporal convolutional architecture may be used to analyze the sequence of frames and predict a smooth 3D trajectory of the club head. In some implementations, the system may also allow the user to mark key frames or provide rough annotations to refine the model's estimates.

At step 706, the reconstructed 3D path is interpolated to produce a consistent sequence of spatial coordinates—typically around 75 data points—each representing the club head's position at evenly spaced time intervals. This interpolation smooths out estimation noise and ensures a continuous, manufacturable trajectory. The result is a stylized yet data-driven line that reflects the tempo, rhythm, and geometry of the user's unique swing.

At step 708, the interpolated path is imported into a computer-aided design (CAD) platform. A loft or sweep operation is applied along the path using a set of cross-sectional profiles defined at key intervals. These profiles may take the form of triangles, ribbons, or organically curved shapes, and are oriented normal to the path at each control point. Importantly, the profiles may vary in size, width, or twist based on swing dynamics inferred from the data—for example, increasing width during moments of maximum club head speed or twisting the form more tightly during the transition from backswing to downswing. This variable geometry adds both aesthetic value and biomechanical expressiveness to the final sculpture.

At step 710, the three-dimensional model is exported in a format suitable for digital fabrication—such as STL, STEP, or OBJ—and used to produce a physical sculpture. Manufacturing may be done using additive techniques, such as resin or metal 3D printing, or subtractive processes like CNC milling. The resulting sculpture captures not only the spatial arc of the swing, but also an embedded visual rhythm, transforming the motion into a tangible piece of personalized kinetic art.

This process allows users—ranging from amateur golfers to professionals—to preserve and display their swings as high-quality sculptures with minimal technical input. The single-camera approach, enabled by machine learning and depth estimation, lowers the barrier to entry while maintaining fidelity and elegance in the output.

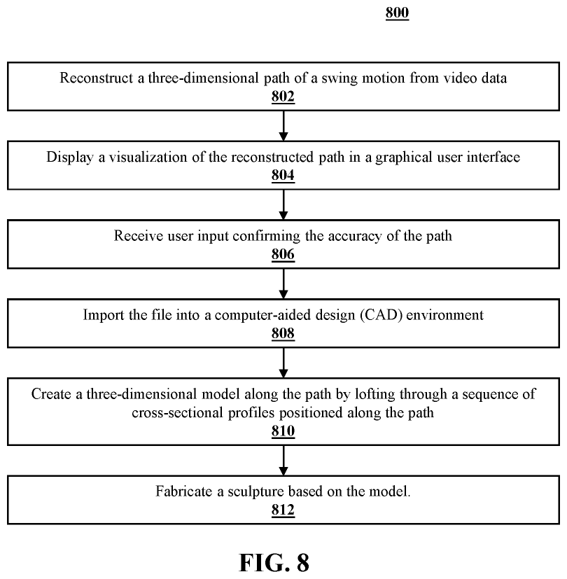

FIG. 8 illustrates a process flow 800 for generating a three-dimensional sculpture of a swing motion, such as a golf swing, with an emphasis on interactive visualization and user validation of the reconstructed data prior to fabrication, in accordance with one or more embodiments of the present invention.

At step 802, a three-dimensional path of a swing motion is reconstructed from video data. The source video may be captured using one or more cameras, and processed using triangulation, depth estimation, or geometric calibration techniques as described in earlier embodiments. The output of this reconstruction is a series of spatial coordinates representing the path of the golf club head over the duration of the swing. This path forms the digital backbone of the subsequent sculpture.

At step 804, the reconstructed path is displayed in a graphical user interface (GUI). This visualization may be rendered in a custom visualizer built into the software pipeline, or through integration with third-party libraries such as OpenGL, Three.js, or matplotlib in a Python environment. The interface provides an interactive 3D view, allowing the user to rotate, zoom, and inspect the path from multiple angles. In some implementations, the interface overlays time-indexed points or velocity vectors along the path to convey additional information about swing timing and intensity.

At step 806, the system receives user input confirming the accuracy of the displayed path. The user may be prompted to accept the reconstruction, request reprocessing, or manually adjust individual points. For example, the user could drag a misaligned point back onto the correct trajectory or use frame-based controls to fine-tune the start and end frames of the swing. This step allows for a final layer of quality control and personalization before the data is locked for modeling.

At step 808, once the path is confirmed, it is exported and imported into a computer-aided design (CAD) environment such as Fusion 360®. The spatial coordinates may be converted into a spline or polyline that defines the central axis of the sculpture. The CAD environment serves as the design canvas for generating the physical form of the sculpture.

At step 810, a three-dimensional model is created along the validated path. This is done by placing a sequence of cross-sectional profiles—such as triangular, circular, or twisted ribbon shapes—along the path and lofting or sweeping through them to form a continuous solid body. The size, orientation, and complexity of each profile may vary based on attributes of the swing data, such as speed, curvature, or moment of impact. In one implementation, the lofted body is also parametrically shaped to enhance artistic expression while preserving motion fidelity.

At step 812, the completed model is fabricated as a physical sculpture. The fabrication method may include additive manufacturing techniques such as resin or metal 3D printing, or subtractive methods like CNC milling. Optionally, the sculpture may be mounted on a base and include additional features such as embedded lighting, QR codes, or engraved performance metadata. The result is a tangible, data-driven artifact that captures both the geometry and rhythm of the original swing.

This process flow enables an intuitive and user-centered pipeline, where the individual can visualize and verify their swing data before it becomes a permanent physical object—bridging the gap between motion capture and personalized sculpture with both precision and creativity.

The foregoing detailed description is intended to be illustrative and not restrictive. Many variations and modifications will become apparent to those skilled in the art upon reading the above description. The scope of the invention should, therefore, be determined not with reference to the above description, but instead should be determined with reference to the appended claims along with their full scope of equivalents.

It should be understood that the order of steps or operations described in the embodiments disclosed herein is not necessarily required to be performed in the exact sequence described unless otherwise stated. Steps may be added, removed, or reordered without departing from the scope of the invention.

All publications, patents, and patent applications cited in this specification are incorporated by reference in their entirety for all purposes to the same extent as if each individual publication, patent, or patent application were specifically and individually indicated to be so incorporated by reference.

Although specific embodiments of the invention have been described and illustrated herein, it will be appreciated by those skilled in the art that various modifications, substitutions, and changes can be made without departing from the scope of the invention.

What is claimed is:

1. A computer-implemented method for creating a physical three-dimensional artifact representing an athletic motion, the method comprising:
obtaining motion data corresponding to movement of an athletic object or body portion during performance of the athletic motion;
generating, from the motion data, a three-dimensional trajectory comprising a plurality of positions distributed along the athletic motion;
generating a digital three-dimensional model by defining a body extending along the three-dimensional trajectory, wherein at least one geometric attribute of the body varies along the three-dimensional trajectory as a function of one or more motion-derived attributes associated with the athletic motion; and
fabricating the digital three-dimensional model as a physical three-dimensional artifact.

2. The method of claim 1, wherein obtaining the motion data comprises receiving video captured by a plurality of cameras viewing a golf swing from different viewpoints and reconstructing the three-dimensional trajectory of a golf club head using triangulation.

3. The method of claim 1, wherein obtaining the motion data comprises receiving monocular video and generating the three-dimensional trajectory using one or more machine-learning models configured to estimate depth, three-dimensional position, or both from the monocular video.

4. The method of claim 1, wherein obtaining the motion data comprises receiving video from a single camera and reconstructing the three-dimensional trajectory using camera calibration information determined from at least one calibration reference visible in the video.

5. The method of claim 4, wherein reconstructing the three-dimensional trajectory further comprises estimating camera intrinsic parameters, camera extrinsic parameters, or both, and determining three-dimensional positions of a tracked object by using image-plane coordinates together with one or more geometric constraints.

6. The method of claim 5, wherein the one or more geometric constraints comprise at least one of: a ground-plane constraint, a club-length constraint, a body-pose constraint, an event-anchor constraint, a phase-specific height constraint, or a reprojection-consistency constraint.

7. The method of claim 1, wherein the one or more motion-derived attributes comprise one or more of speed, acceleration, curvature, torsion, tempo, transition timing, impact timing, angular velocity, or path symmetry.

8. The method of claim 1, wherein generating the digital three-dimensional model comprises fitting a spline, curve, or centerline to the three-dimensional trajectory and performing a lofting, sweeping, extrusion, shelling, or thickening operation relative to the spline, curve, or centerline.

9. The method of claim 1, wherein the physical three-dimensional artifact comprises a sculpture representing a golf swing, a tennis stroke, a baseball swing, a baseball pitch, a basketball shot, or a figure-skating motion.

10. The method of claim 1, further comprising displaying a rendering of the three-dimensional trajectory in a user interface prior to fabrication and receiving user input approving or editing the three-dimensional trajectory.

11. The method of claim 1, wherein fabricating the digital three-dimensional model comprises additive manufacturing, lost-wax casting, CNC machining, or a combination thereof.

12. The method of claim 1, wherein the physical three-dimensional artifact is configured as a wearable article comprising a pendant, earring, ring, bracelet, cuff, charm, pin, or other jewelry item.

13. The method of claim 12, wherein generating the digital three-dimensional model further comprises applying a jewelry-conversion process including one or more of scaling, smoothing, local thickening, balance adjustment, attachment-feature generation, orientation optimization, edge rounding, manufacturability validation, or material-specific adaptation.

14. A system for generating an interactive physical representation of an athletic motion, the system comprising:
a memory storing motion data representing a reconstructed three-dimensional trajectory associated with the athletic motion;
a physical body extending along a path derived from the reconstructed three-dimensional trajectory;
one or more output devices associated with the physical body or a support base for the physical body; and
a control subsystem configured to drive the one or more output devices according to playback data derived from the motion data so as to generate a time-varying replay of at least a portion of the athletic motion.

15. The system of claim 14, wherein the one or more output devices comprise one or more light-emitting elements arranged along at least a portion of the physical body, and wherein the control subsystem is configured to activate the one or more light-emitting elements in sequence according to a position-to-output mapping corresponding to progression through the reconstructed three-dimensional trajectory.

16. The system of claim 14, wherein the one or more output devices comprise at least one haptic output device, and wherein the control subsystem is configured to generate an event-based haptic output schedule corresponding to one or more events identified in the athletic motion.

17. The system of claim 14, further comprising at least one sensor configured to detect user presence, touch, proximity, gesture, or motion, wherein the control subsystem is configured to initiate a playback mode in response to an output of the at least one sensor.

18. The system of claim 14, further comprising a wireless communication subsystem configured to communicate with a mobile device or external application to adjust playback settings, select among stored motion profiles, synchronize playback with external media, or update control data.

19. A physical article comprising:
a three-dimensional body having a longitudinal extent along a path corresponding to a reconstructed athletic-motion trajectory;
wherein the three-dimensional body includes geometric variation along the path that encodes one or more motion-derived attributes of the reconstructed athletic-motion trajectory; and
a mounting interface or wearable attachment feature configured to support the three-dimensional body as a display object or wearable article.

20. The physical article of claim 19, wherein the geometric variation comprises variation in one or more of cross-sectional size, cross-sectional shape, thickness, twist, flare, faceting, ribbing, surface texture, or local ornamentation along the path.
